(19) United States
(12) Patent Application Publication
(10) Pub. No.: US 2026/0095865 A1
(43) Pub. Date: Apr. 2, 2026

(54) TECHNIQUES FOR DRX-AUGMENTED LOW-POWER WAKE-UP SIGNAL PDCCH MONITORING

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Hemant SAGGAR, San Diego, CA (US); Kazuki TAKEDA, Minato-ku (JP); Jelena DAMNJANOVIC, Del Mar, CA (US); Junyi LI, Greentown, PA (US); Tao LUO, San Diego, CA (US)

(21) Appl. No.: 19/229,947

(22) Filed: Jun. 5, 2025

Related U.S. Application Data
(60) Provisional application No. 63/702,507, filed on Oct. 2, 2024.

(51) Int. Cl. H04W 52/02; H04W 72/0446; H04W 72/23

(52) U.S. Cl. CPC H04W 52/0235; H04W 72/0446; H04W 72/23

(57) ABSTRACT

Methods, systems, and devices for wireless communications are described. A user equipment (UE) may be configured with a first set of low-power wake up signal (LP-WUS) monitoring occasions associated with a discontinuous reception (DRX) configuration at the UE and/or a second set of LP-WUS monitoring occasions. The first set of LP-WUS monitoring occasions is usable for triggering a first set of physical downlink control channel (PDCCH) monitoring occasions of the DRX configuration, and the second set of LP-WUS monitoring occasions is usable for triggering a second set of PDCCH monitoring occasions that are separate from the DRX configuration. The UE may then receive a LP-WUS within one of the first set of LP-WUS monitoring occasions or the second set of LP-WUS monitoring occasions, and monitor for a PDCCH message within a PDCCH occasion from the first set of PDCCH monitoring occasions or the second set of PDCCH monitoring occasions.

### CROSS REFERENCE

The present Application for Patent claims the benefit of U.S. Provisional Patent Application No. 63/702,507 by Ryu et al, entitled “TECHNIQUES FOR DRX-AUGMENTED LOW-POWER WAKE-UP SIGNAL PDCCH MONITORING,” filed Oct. 2, 2024, assigned to the assignee hereof, and expressly incorporated by reference herein.

### FIELD OF TECHNOLOGY

The following relates to wireless communications, including techniques for discontinuous reception (DRX)-augmented low-power wake-up signal (LP-WUS) physical downlink control channel (PDCCH) monitoring.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, wireless devices (e.g., UEs) may utilize different mechanisms for reducing power consumption. For example, UEs may operate according to a discontinuous reception (DRX) configuration, where the UE transitions between “active states” (higher power consumption states) and “inactive states” (lower power consumption states). In the context of a DRX configuration, the UE may be expected to “wake up” for short periods of time during the inactive states to monitor for “wake up” control signaling (such as downlink control information of power saving (DCP) messaging) that indicates whether or not the network has data to communicate to UE, and therefore determine whether the UE is expected to wake up to monitor for physical downlink control channel (PDCCH) signaling during a PDCCH monitoring occasion within the next active state. However, the UE may be expected to activate the main radio of the UE in order to monitor for the “wake up” control signaling, which increases the power consumption of the UE during the inactive states of the DRX configuration.

### SUMMARY

The systems, methods, and devices of this disclosure each have several innovative aspects, no single one of which is solely responsible for the desirable attributes disclosed herein.

A method by a user equipment (UE) is described. The method may include receiving, from a network entity, control signaling indicating at least one of a first set of low-power wake up signal (LP-WUS) monitoring occasions associated with a discontinuous reception (DRX) configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, receiving a LP-WUS within one of the first set of LP-WUS monitoring occasions or the second set of LP-WUS monitoring occasions, and monitoring for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

A UE is described. The UE may include one or more memories storing processor executable code, and one or more processors coupled with the one or more memories. The one or more processors may individually or collectively be operable to execute the code to cause the UE to receive, from a network entity, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, receive a LP-WUS within one of the first set of LP-WUS monitoring occasions or the second set of LP-WUS monitoring occasions, and monitor for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

Another UE is described. The UE may include means for receiving, from a network entity, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, means for receiving a LP-WUS within one of the first set of LP-WUS monitoring occasions or the second set of LP-WUS monitoring occasions, and means for monitoring for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

A non-transitory computer-readable medium storing code is described. The code may include instructions executable by one or more processors to receive, from a network entity, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, receive a LP-WUS within one of the first set of LP-WUS monitoring occasions or the second set of LP-WUS monitoring occasions, and monitor for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

In some examples of the method, UEs, and non-transitory computer-readable medium described herein, a position of the first set of LP-WUS monitoring occasions in a time domain may be determined based on a position of the first set of downlink control channel monitoring occasions of the DRX configuration in the time domain.

In some examples of the method, UEs, and non-transitory computer-readable medium described herein, a position of the second set of downlink control channel monitoring occasions in a time domain may be based on a position of the second set of LP-WUS monitoring occasions in the time domain.

In some examples of the method, UEs, and non-transitory computer-readable medium described herein, a second periodicity of the second set of LP-WUS monitoring occasions may be shorter than a first periodicity of the first set of LP-WUS monitoring occasions such that each DRX period includes multiple LP-WUS monitoring occasions from the second set of LP-WUS monitoring occasions.

Some examples of the method, UEs, and non-transitory computer-readable medium described herein may further include operations, features, means, or instructions for receiving an indication to change the second periodicity of the second set of LP-WUS monitoring occasions, where reception of the LP-WUS, the downlink control channel message being monitored for, or both, may be based on reception of the indication to change the second periodicity.

In some examples of the method, UEs, and non-transitory computer-readable medium described herein, each LP-WUS monitoring occasion from the first set of LP-WUS monitoring occasions may be positioned a first offset prior to a corresponding downlink control channel monitoring occasion from the first set of downlink control channel monitoring occasions in a time domain and each downlink control channel monitoring occasion from the second set of downlink control channel monitoring occasions may be positioned a second offset subsequent to a LP-WUS monitoring occasion from the second set of LP-WUS monitoring occasions used to receive a respective LP-WUS.

Some examples of the method, UEs, and non-transitory computer-readable medium described herein may further include operations, features, means, or instructions for activating a first on-duration timer associated with the DRX configuration if the LP-WUS may be received within one of the first set of LP-WUS monitoring occasions, where the downlink control channel message may be monitored for within a downlink control channel monitoring occasion from the first set of downlink control channel monitoring occasions while the first on-duration timer may be running and activating a second on-duration timer that may be different from the first on-duration timer and separate from the DRX configuration if the LP-WUS may be received within one of the second set of LP-WUS monitoring occasions, where the downlink control channel message may be monitored for within a downlink control channel monitoring occasion from the second set of downlink control channel monitoring occasions while the second on-duration timer may be running.

Some examples of the method, UEs, and non-transitory computer-readable medium described herein may further include operations, features, means, or instructions for activating a first inactivity timer associated with the DRX configuration if the LP-WUS may be received within one of the first set of LP-WUS monitoring occasions and a downlink control channel message may be received within one of the first set of downlink control channel monitoring occasions, and activating a second inactivity timer that may be different from the first inactivity timer and independent from the DRX configuration if the LP-WUS may be received within one of the second set of LP-WUS monitoring occasions and the downlink control channel message may be received within one of the second set of downlink control channel monitoring occasions.

In some examples of the method, UEs, and non-transitory computer-readable medium described herein, the first set of downlink control channel monitoring occasions of the DRX configuration may be usable for transmission of a sounding reference signal (SRS), a channel state information (CSI) report, or both and the second set of downlink control channel monitoring occasions may be not usable for transmission of an SRS, a CSI report, or both.

Some examples of the method, UEs, and non-transitory computer-readable medium described herein may further include operations, features, means, or instructions for refraining from monitoring a second LP-WUS monitoring occasion from the second set of LP-WUS monitoring occasions based on the second LP-WUS monitoring occasion occurring between a first LP-WUS monitoring occasion from the first set of LP-WUS monitoring occasions and a corresponding downlink control channel monitoring occasion from the first set of downlink control channel monitoring occasions in a time domain.

Some examples of the method, UEs, and non-transitory computer-readable medium described herein may further include operations, features, means, or instructions for activating a first on-duration timer associated with the DRX configuration, a first inactivity timer associated with the DRX configuration, or both, based on reception of the LP-WUS within one of the first set of LP-WUS monitoring occasions and refraining from monitoring an LP-WUS monitoring occasion from the second set of LP-WUS monitoring occasions based on the LP-WUS monitoring occasion occurring while the first on-duration timer or the first inactivity timer may be running.

In some examples of the method, UEs, and non-transitory computer-readable medium described herein, the LP-WUS received within one of the first set of LP-WUS monitoring occasions or the second set of LP-WUS monitoring occasions includes an on-off keying (OOK) waveform.

In some examples of the method, UEs, and non-transitory computer-readable medium described herein, the control signaling may be received via a main radio of the UE, the LP-WUS may be received via a low-power wake-up receiver (LP-WUR) of the UE, and monitoring for the downlink control channel message may be performed using the main radio.

A method by a network entity is described. The method may include outputting, to a UE, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, outputting a LP-WUS within one of the first set of LP-WUS monitoring occasions or the second set of LP-WUS monitoring occasions, and outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

A network entity is described. The network entity may include one or more memories storing processor executable code, and one or more processors coupled with the one or more memories. The one or more processors may individually or collectively be operable to execute the code to cause the network entity to output, to a UE, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, output a LP-WUS within one of the first set of LP-WUS monitoring occasions or the second set of LP-WUS monitoring occasions, and output a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

Another network entity is described. The network entity may include means for outputting, to a UE, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, means for outputting a LP-WUS within one of the first set of LP-WUS monitoring occasions or the second set of LP-WUS monitoring occasions, and means for outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

A non-transitory computer-readable medium storing code is described. The code may include instructions executable by one or more processors to output, to a UE, control signaling indicating at least one of a first set of LP-WUS monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration, output a LP-WUS within one of the first set of LP-WUS monitoring occasions or the second set of LP-WUS monitoring occasions, and output a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

In some examples of the method, network entities, and non-transitory computer-readable medium described herein, a position of the first set of LP-WUS monitoring occasions in a time domain may be determined based on a position of the first set of downlink control channel monitoring occasions of the DRX configuration in the time domain.

In some examples of the method, network entities, and non-transitory computer-readable medium described herein, a position of the second set of downlink control channel monitoring occasions in a time domain may be based on a position of the second set of LP-WUS monitoring occasions in the time domain.

In some examples of the method, network entities, and non-transitory computer-readable medium described herein, a second periodicity of the second set of LP-WUS monitoring occasions may be shorter than a first periodicity of the first set of LP-WUS monitoring occasions such that each DRX period includes multiple LP-WUS monitoring occasions from the second set of LP-WUS monitoring occasions.

Some examples of the method, network entities, and non-transitory computer-readable medium described herein may further include operations, features, means, or instructions for outputting an indication to change the second periodicity of the second set of LP-WUS monitoring occasions, where output of the LP-WUS, output of the downlink control channel message, or both, may be based on output of the indication to change the second periodicity.

In some examples of the method, network entities, and non-transitory computer-readable medium described herein, each LP-WUS monitoring occasion from the first set of LP-WUS monitoring occasions may be positioned a first offset prior to a corresponding downlink control channel monitoring occasion from the first set of downlink control channel monitoring occasions in a time domain and each downlink control channel monitoring occasion from the second set of downlink control channel monitoring occasions may be positioned a second offset subsequent to a LP-WUS monitoring occasion from the second set of LP-WUS monitoring occasions used to receive a respective LP-WUS.

In some examples of the method, network entities, and non-transitory computer-readable medium described herein, if the LP-WUS may be output within one of the first set of LP-WUS monitoring occasions, the LP-WUS indicates to activate a first on-duration timer associated with the DRX configuration, the downlink control channel message may be output within a downlink control channel monitoring occasion from the first set of downlink control channel monitoring occasions while the first on-duration timer may be running, if the LP-WUS may be output within one of the second set of LP-WUS monitoring occasions, the LP-WUS indicates to activate a second on-duration timer that may be different from the first on-duration timer and independent from the DRX configuration, and the downlink control channel message may be output within a downlink control channel monitoring occasion from the second set of downlink control channel monitoring occasions while the second on-duration timer may be running.

In some examples of the method, network entities, and non-transitory computer-readable medium described herein, if the LP-WUS may be output within one of the first set of LP-WUS monitoring occasions and the downlink control channel message may be output within one of the first set of downlink control channel monitoring occasions, the downlink control channel message indicates to activate a first inactivity timer associated with the DRX configuration and if the LP-WUS may be output within one of the second set of LP-WUS monitoring occasions and the downlink control channel message may be output within one of the second set of downlink control channel monitoring occasions, the downlink control channel message indicates to activate a second inactivity timer that may be different from the first inactivity timer and independent from the DRX configuration.

In some examples of the method, network entities, and non-transitory computer-readable medium described herein, the first set of downlink control channel monitoring occasions of the DRX configuration may be usable for output of an SRS, a CSI report, or both and the second set of downlink control channel monitoring occasions may be not usable for output of an SRS, a CSI report, or both.

In some examples of the method, network entities, and non-transitory computer-readable medium described herein, the LP-WUS output within one of the first set of LP-WUS monitoring occasions or the second set of LP-WUS monitoring occasions includes an OOK waveform.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for discontinuous reception (DRX)-augmented low-power wake-up signal (LP-WUS) physical downlink control channel (PDCCH) monitoring in accordance with one or more aspects of the present disclosure.

FIG. 2 shows an example of a wireless communications system that supports techniques for DRX-augmented LP-WUS PDCCH monitoring in accordance with one or more aspects of the present disclosure.

FIG. 3 shows an example of a DRX configuration that supports techniques for DRX-augmented LP-WUS PDCCH monitoring in accordance with one or more aspects of the present disclosure.

FIG. 4 shows an example of a monitoring configuration that supports techniques for DRX-augmented LP-WUS PDCCH monitoring in accordance with one or more aspects of the present disclosure.

FIG. 5 shows an example of a process flow that supports techniques for DRX-augmented LP-WUS PDCCH monitoring in accordance with one or more aspects of the present disclosure.

FIGS. 6 and 7 show block diagrams of devices that support techniques for DRX-augmented LP-WUS PDCCH monitoring in accordance with one or more aspects of the present disclosure.

FIG. 8 shows a block diagram of a communications manager that supports techniques for DRX-augmented LP-WUS PDCCH monitoring in accordance with one or more aspects of the present disclosure.

FIG. 9 shows a diagram of a system including a device that supports techniques for DRX-augmented LP-WUS PDCCH monitoring in accordance with one or more aspects of the present disclosure.

FIGS. 10 and 11 show block diagrams of devices that support techniques for DRX-augmented LP-WUS PDCCH monitoring in accordance with one or more aspects of the present disclosure.

FIG. 12 shows a block diagram of a communications manager that supports techniques for DRX-augmented LP-WUS PDCCH monitoring in accordance with one or more aspects of the present disclosure.

FIG. 13 shows a diagram of a system including a device that supports techniques for DRX-augmented LP-WUS PDCCH monitoring in accordance with one or more aspects of the present disclosure.

FIGS. 14 and 15 show flowcharts illustrating methods that support techniques for DRX-augmented LP-WUS PDCCH monitoring in accordance with one or more aspects of the present disclosure.

### DETAILED DESCRIPTION

In some wireless communications systems, wireless devices (e.g., user equipments (UEs)) may utilize different mechanisms for reducing power consumption. For example, UEs may operate according to a discontinuous reception (DRX) configuration, where the UE transitions between “active states” (higher power consumption states) and “inactive states” (lower power consumption states). In the context of a DRX configuration, the UE may be expected to “wake up” for short periods of time during the inactive state to monitor for “wake up” control signaling (such as downlink control information of power saving (DCP) messaging) that indicates whether the network has data to communicate to UE, and therefore determine whether the UE is expected to wake up to monitor for physical downlink control channel (PDCCH) signaling during a PDCCH monitoring occasion within the next active state. However, the UE may be expected to activate the main radio of the UE in order to monitor for the “wake up” control signaling, which can increase the power consumption of the UE during the inactive states of the DRX configuration.

Another power-saving mechanism used by some wireless devices is low-power wake-up signals (LP-WUSs). Similar to the “wake up” control signaling in the DRX configuration, the network may utilize LP-WUSs to indicate whether the network has data to deliver to the UE, and therefore indicate for the UE to switch on the main radio to monitor for PDCCH signaling in a PDCCH monitoring occasion. LP-WUSs utilize simpler waveforms as compared to the “wake up” control signaling used in the DRX context (e.g., LP-WUSs exhibit simpler waveforms compared to PDCCH signaling, such as DCP messages). As such, LP-WUSs can be received via a low-power wake-up receive (LP-WUR), which may be a relatively simpler and relatively less power-intensive compared to a main radio, thereby reducing the power consumption at the UE as the UE monitors for LP-WUSs while in an inactive state. However, some wireless communications systems may be incapable of utilizing DRX configurations and LP-WUSs in conjunction with one another.

Accordingly, aspects of the present disclosure are directed to techniques that utilize LP-WUSs for triggering PDCCH monitoring in the context of a DRX configuration, as well as for triggering PDCCH monitoring that is unrelated to the DRX configuration. In particular, aspects of the present disclosure may be directed to techniques that enable wireless devices to monitor for LP-WUSs for DRX-triggered PDCCH monitoring, LP-WUSs for non-DRX triggered PDCCH monitoring, or a combination thereof.

For example, a UE may be configured with a first set of LP-WUS monitoring occasions that are used to trigger PDCCH monitoring occasions associated with a DRX configuration (e.g., DRX-related LP-WUS monitoring occasions), and a second set of LP-WUS monitoring occasions that are used to trigger PDCCH monitoring occasions that are separate from the DRX configuration (e.g., non-DRX LP-WUS monitoring occasions). The periodicity or offset of the respective sets of LP-WUS monitoring occasions may be different. Within each LP-WUS monitoring occasion, the UE may monitor, search, or receive LP-WUS within configured time and frequency resources. The UE may then be configured to monitor both sets of LP-WUS monitoring occasions, and trigger DRX-related or non-DRX-related PDCCH monitoring occasions based on whether an LP-WUS is received within the first set of LP-WUS monitoring occasions associated the DRX configuration or the second set of LP-WUS monitoring occasions that are separate from the DRX configuration.

Techniques described herein may enable the UE to be configured with multiple different sets of LP-WUS monitoring occasions, thereby providing more opportunities for the network to alert the UE of data traffic, and enabling the UE to trigger active periods more frequently. As such, techniques described herein may reduce a latency of downlink traffic from the network to the UE. Furthermore, by utilizing LP-WUSs to trigger PDCCH monitoring in the context of a DRX configuration, aspects of the present disclosure may enable the UE to perform LP-WUS monitoring using an LP-WUR that exhibits lower power consumption as compared to the main radio. Therefore, techniques described herein may further lower a power consumption at the UE associated with performing LP-WUS monitoring during inactive periods of a DRX cycle.

Aspects of the disclosure are initially described in the context of wireless communications systems. Additional aspects of the disclosure are described in the context of an example DRX configuration, an example LP-WUS triggered control channel monitoring configuration, and an example process flow. Aspects of the disclosure are further illustrated by and described with reference to apparatus diagrams, system diagrams, and flowcharts that relate to techniques for DRX-augmented LP-WUS PDCCH monitoring.

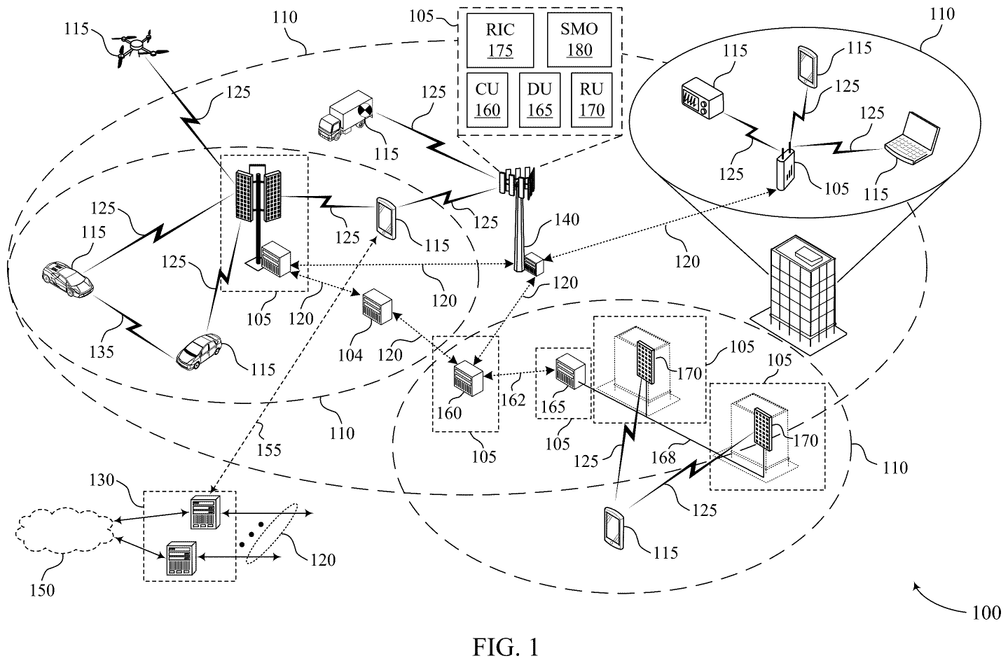

FIG. 1 shows an example of a wireless communications system 100 that supports techniques for DRX-augmented LP-WUS PDCCH monitoring in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for DRX-augmented LP-WUS PDCCH monitoring as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective wireless devices of the wireless communications system 100 (e.g., UEs 115, network entities 105, IoT devices, IAB nodes, etc.) may support signaling and configurations that utilize LP-WUSs for triggering PDCCH monitoring in the context of a DRX configuration, and for triggering PDCCH monitoring that is unrelated to the DRX configuration. In particular, aspects of the present disclosure are directed to techniques that enable wireless devices to monitor for both: (1) LP-WUSs for DRX-triggered PDCCH monitoring, (2) LP-WUSs for non-DRX triggered PDCCH monitoring.

For example, a UE 115 of the wireless communications system 100 may be configured with a DRX configuration. In this example, the UE 115 may be configured with a first set of LP-WUS monitoring occasions that are used to trigger PDCCH monitoring occasions associated with the DRX configuration (e.g., DRX-related LP-WUS monitoring occasions), and a second set of LP-WUS monitoring occasions that are used to trigger PDCCH monitoring occasions that are separate from (e.g., not associated with, independent from) the DRX configuration (e.g., non-DRX LP-WUS monitoring occasions). The periodicity or offset of the respective sets of LP-WUSs may be different. Within each LP-WUS monitoring occasion, the UE 115 may monitor, search, or receive a LP-WUS within configured time and frequency resources. The UE 115 may then be configured to monitor both sets of LP-WUS monitoring occasions, and trigger DRX-related or non-DRX-related PDCCH monitoring occasions based on whether an LP-WUS is received within the first set of LP-WUS monitoring occasions associated the DRX configuration or the second set of LP-WUS monitoring occasions that are separate from the DRX configuration.

Techniques described herein may enable the UEs 115 of the wireless communications system 100 to be configured with multiple different sets of LP-WUS monitoring occasions, thereby providing more opportunities for the network to alert the UEs 115 of data traffic, and enabling the UEs 115 to trigger active periods more frequently. As such, techniques described herein may reduce a latency of downlink traffic from the network to the UEs 115. Furthermore, by utilizing LP-WUSs to trigger PDCCH monitoring in the context of a DRX configuration, aspects of the present disclosure may enable UEs 115 to perform LP-WUS monitoring using an LP-WUR that exhibits lower power consumption as compared to the main radio. Therefore, techniques described herein may further lower a power consumption at the UEs 115 associated with performing LP-WUS monitoring during inactive periods of a DRX cycle.

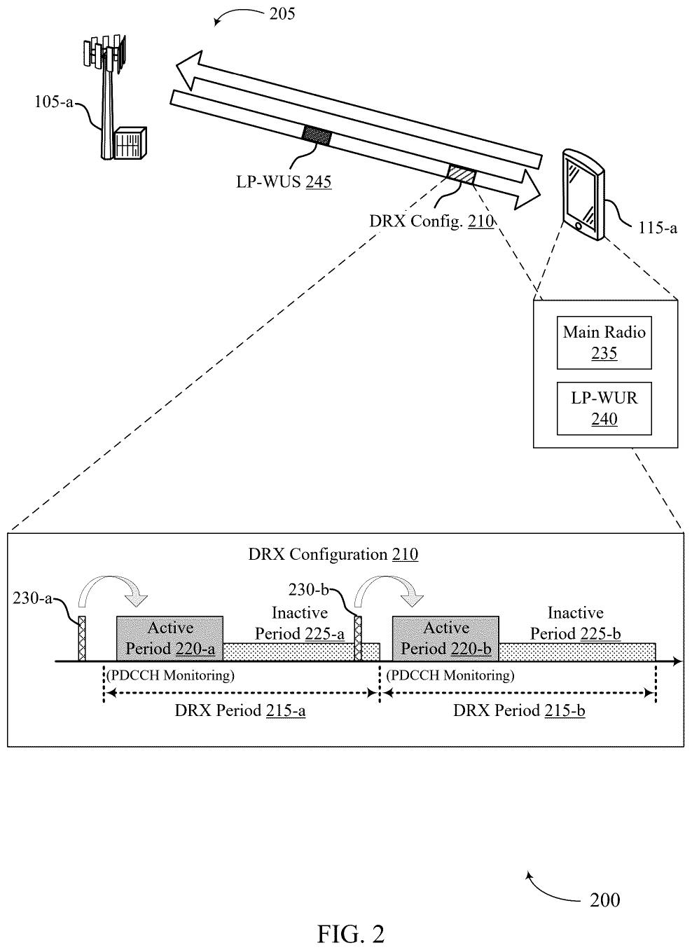

FIG. 2 shows an example of a wireless communications system 200 that supports techniques for DRX-augmented LP-WUS PDCCH monitoring in accordance with one or more aspects of the present disclosure. In some examples, aspects of the wireless communications system 200 may implement, or be implemented by, aspects of the wireless communications system 100. In particular, the wireless communications system 200 may support multiple different sets of LP-WUS monitoring occasions for triggering DRX-related PDCCH monitoring and non-DRX-related PDCCH monitoring, as described herein.

The wireless communications system 200 may include a network entity 105-a and a UE 115-a, which may be examples of wireless devices as described herein. In some aspects, the network entity 105-a and the UE 115-a may communicate with one another using a communication link 205, which may be an example of an NR or LTE link, sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205, and one or more components of the network entity 105-a may transmit downlink signals, such as downlink control signals or downlink data signals, to the UE 115-a using the communication link 205.

As noted elsewhere herein, in some wireless communications systems (e.g., the wireless communications system 100, the wireless communications system 200, or both), wireless devices (e.g., UEs 115) may utilize different mechanisms for reducing power consumption. For example, UEs 115 may operate according to a DRX configuration, where the UE 115 transitions between “active states” (higher power consumption) and “inactive states” (lower power consumption). For instance, as shown in the wireless communications system 200 illustrated within FIG. 2, the UE 115-a may be configured with a DRX configuration 210 that includes multiple repeating DRX periods 215-a, 215-b. Each DRX period 215 may include an active period 220-a, 220-b and an inactive period 225-a, 225-b. In some cases, the active periods 220 of the DRX configuration may additionally, or alternatively, be referred to as downlink control channel monitoring occasions, or PDCCH monitoring occasions.

Connected-mode DRX (C-DRX) may be a UE 115 power saving procedure in which UE 115 periodically wakes up to monitor for “wake up” control messages from network, such as DCP messages. For instance, as shown in the DRX configuration 210, the UE 115-a may be expected to periodically wake up to monitor for DCP messages (which are a type of PDCCH signaling) during designated monitoring occasions 230 (e.g., a monitoring occasion 230-a, a monitoring occasion 230-b). The network may use such DCP messages within the monitoring occasions 230- to indicate whether the network has data to deliver to the UE 115-a. As such, the network may use the monitoring occasions 230 to trigger the UE 115-a to turn on the main radio in active periods 220 that are subsequent to each other (e.g., an active period 220-a, an active period 220-b, or both where the UE 115-a wake up for PDCCH monitoring occasions) so that the UE 115-a can receive data from the network. In the context of C-DRX, when the UE 115 is not monitoring for PDCCH, the UE 115 is allowed to go into a sleep state (e.g., low-power state, inactive period 225).

In some examples, the periodicity of DCP monitoring for C-DRX may be fixed once configured. That is, the periodicity of the PDCCH monitoring occasions 230 for receiving the DCP messages may be fixed once the UE 115-a is configured with the DRX configuration 210. As such, the UE 115 may be expected to wake up and monitor for DCP messages during every PDCCH monitoring occasion 230 and/or during every “on duration” (e.g., active period 220, PDCCH monitoring occasion) even when there is a lack of data for the network to transmit to the UE 115 (e.g., the UE 115-a). Additionally, or alternatively, in the context of C-DRX, the network may utilize DCP messages during the monitoring occasion 230-a, the monitoring occasion 230-b, or both in order to trigger the active periods 220 (e.g., trigger PDCCH monitoring occasions) of the DRX periods 215. Such DCP messages may include complex waveforms that must be received and processed by a main radio 235 at the UE 115-a. That is, the UE 115-a may be expected to turn on the main radio 235 for every monitoring occasion 230 (and during every active period 220/PDCCH monitoring occasion), which can further increase the energy consumption at the UE 115-a. Such increases in energy consumptions at the UE 115-a may limit the power saving gains and latency performance of C-DRX configurations.

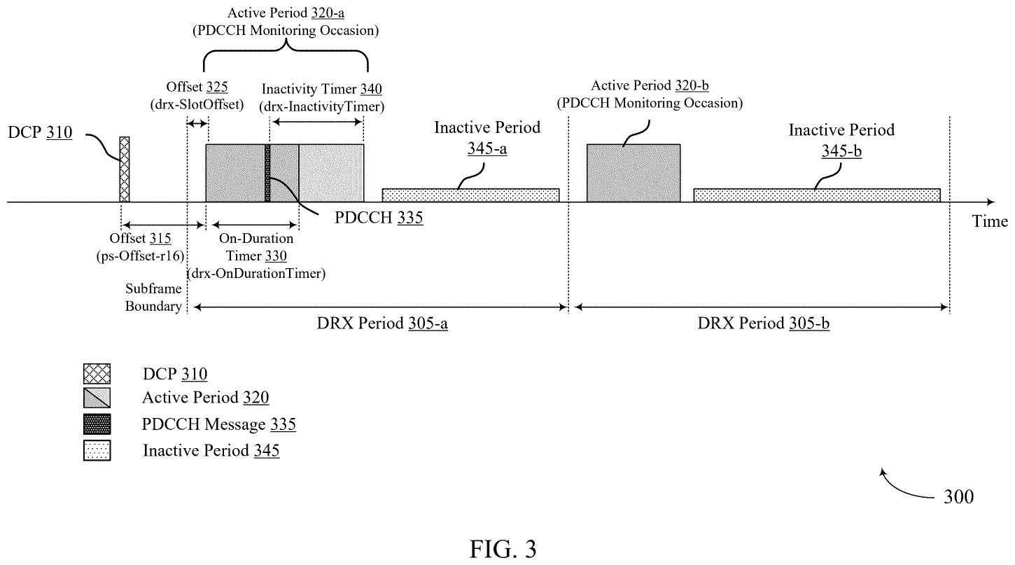

Therefore, in accordance with the techniques of the present disclosure, to increase the power saving gains and reduce the latency of communications, the UE 115-a may be configured with multiple different sets of LP-WUS monitoring occasions (e.g., DRX-related LP-WUS monitoring occasions, and non-DRX-related LP-WUS monitoring occasions), where the network (e.g., the network entity 105) is able to activate/indicate which set of LP-WUS monitoring occasions is to be used for triggering PDCCH monitoring occasions. For example, the UE 115-a may receive, from the network entity 105-a, control signaling indicating a first set of LP-WUS monitoring occasions associated with a DRX configuration at the UE 115-a, a second set of LP-WUS monitoring occasions usable for triggering PDCCH monitoring occasions that are separated from the DRX configuration, or both. In some examples, the UE 115-a may be capable of being configured with the first set of LP-WUS monitoring occasions or the second set of LP-WUS monitoring occasions and may be unable to be configured with both sets. In some other examples, the UE 115-a may receive a single control message or multiple control messages to configure the UE 115-a with both the first set of LP-WUS monitoring occasions and/or the second set of LP-WUS monitoring occasions. The non-DRX LP-WUS monitoring occasions may provide increased flexibility of the PDCCH monitoring occasions as compared to the DRX configuration. In particular, the non-PDCCH monitoring occasions may be able to “float” or “shift” in the time domain based on the non-DRX LP-WUS monitoring occasions, which may reduce the latency of downlink traffic delivered to the UE 115. Further descriptions of C-DRX configurations may be described elsewhere herein, such as with reference to FIG. 3.

FIG. 3 shows an example of a DRX configuration 300 (e.g., C-DRX configuration) that supports techniques for DRX-augmented LP-WUS PDCCH monitoring in accordance with one or more aspects of the present disclosure. In some examples, aspects of the DRX configuration 300 may implement, or be implemented by, aspects of the wireless communications system 100, the wireless communications system 200, or both. For example, the DRX configuration 300 shown in FIG. 3 may be an example of the DRX configuration 210 shown and described in FIG. 2, and may include active periods 320 and inactive periods 345.

As shown in FIG. 3, the DRX configuration 300 may include DRX periods 305 that are repeating (e.g., a DRX period 305-a and a DRX period 305-b). Each DRX period 305 may include an active period 320 (e.g., an active period 320-a, an active period 320-b, or both, which may be PDCCH monitoring occasions) and an inactive period 345 (e.g., an inactive period 345-a, an inactive period 345-b, or both). A UE 115 configured with the DRX configuration 300 may be configured to monitor for control signals in PDCCH from the serving cell during the active periods 320. The active periods 320 (e.g., “active time,” PDCCH monitoring occasions) may include time periods where an on-duration timer 330 (e.g., drx-OnDurationTimer) an inactivity timer 340 (e.g., drx-InactivityTimer), or both are configured for the DRX configuration 300 or DRX group is running.

For example, the UE 115 may start the on-duration timer 330 to begin an active period 320-a (e.g., PDCCH monitoring occasion) for a DRX period 305. If the UE 115 receives a PDCCH message 335 during the active period 320-a (e.g., while the on-duration timer 330 is running), the UE 115 may start the inactivity timer 340 in order to extend the active period 320-a (e.g., PDCCH monitoring occasion) to perform some communication scheduled by the PDCCH message 335. That is, if the UE 115 receives a PDCCH message 335 that indicates a new transmission (e.g., downlink, uplink, and/or sidelink message) on a serving cell of the DRX group, the UE 115 may be configured to start or restart the drx-InactivityTimer (e.g., inactivity timer 340) in order to extend the active period 320-a so that the UE 115 can perform the scheduled communication.

In some aspects, the starting subframe of a DRX cycle (e.g., DRX configuration 300) may be determined based on a configuration parameter drx-LongCycleStartOffset. Such DRX configuration parameters may be configured via control signaling (e.g., RRC signaling) from the network.

In some aspects, according to some C-DRX configurations (e.g., DRX configuration 300), the UE 115 may be configured to monitor for DCI of power saving (DCP) messages (DCP messages 310) that are used to trigger the UE 115 to perform PDCCH monitoring during an active period 320 (e.g., subsequent PDCCH monitoring occasion). For example, as described elsewhere herein, such as with reference to FIG. 2, the UE 115 may be configured to monitor for DCP messages 310 during PDCCH monitoring occasions (e.g., monitoring occasions 230), where the DCP messages 310 are used to trigger the UE 115 to “wake up” to monitor for PDCCH signaling in an active period 320.

As shown in FIG. 3, the UE 115 may be configured to initiate an active period 320-a that is some time duration (defined by offset 315) after receiving the DCP message 310. For example, the offset 315 may include ps-Offset-r16, which may define the start of the search-time of DCI format 2 -6 with CRC scrambled by PS-RNTI relative to the start of the drx-onDurationTimer of Long DRX. The value of the offset 315 (e.g., ps-Offset-r16) may be an integer multiple value of 0.125 milliseconds (ms) (e.g., ps-Offset-r16=1 corresponds to 0.125 ms, =2 corresponds to 0.25 ms, =3 corresponds to 0.375 ms, etc.). The active period 320-a of the DRX cycle may start some number of slots, as defined by an offset 325 (e.g., drx-SlotOffset) after the start of the DRX period 305-a. That is, the UE 115 may initiate the on-duration timer 330 (e.g., drx-OnDurationTimer) some amount of time after receiving the DCP message 310, the amount of time based on an offset 315 and offset 325.

DCP messages 310 may include a type of wake-up signal that is transmitted in DCI. As such, DCP messages are a type of PDCCH message, and can therefore only be received via a main radio 235 of the UE 115-a (e.g., can not be received via the LP-WUR 240). As such, using DCP messages 310 to trigger PDCCH monitoring results in increased power consumption at the UE 115 because the UE 115 is unable switch (e.g., transition) the main radio 235 into a deep sleep mode (e.g., main radio 235 may be unable to be completely turned off).

Furthermore, the location of DCP monitoring occasions used to receive the DCP messages 310 may be fixed (e.g., inferred) based on the location of the active periods 320 for a DRX configuration (e.g., PDCCH monitoring occasions) in the time domain. That is, the UE 115 may be configured with the DRX configuration 300, where the DRX periods 305 and/or active periods 320 (e.g., PDCCH monitoring occasions) are static and fixed in the time domain based on the DRX configuration 300. In such cases, the DCP monitoring occasions for receiving DCP messages 310 may be fixed relative to the fixed active periods 320/PDCCH monitoring occasions. The fixed positions of the DCP monitoring occasions relative to the active periods 320 may result in increased latency. For example, if the network has data to communicate to the UE 115, the network may have to wait until a next DCP monitoring occasion (which is fixed based on the DRX configuration 300) in order to transmit a DCP message 310 to the UE 115, which may result in increased latency.

Taken together, some DRX configurations 300 may experience increased power consumption at the UE 115 (resulting from using DCP messages 310 that are received using the main radio 235), and increased latency (due to the position of DCP monitoring occasions being static/fixed relative to the DRX periods 305/active periods 320 of the DRX configuration).

Accordingly, aspects of the present disclosure are directed to configurations and techniques that improve DRX configurations. In particular, aspects of the present disclosure are directed to techniques that combine C-DRX configurations with LP-WUS triggered PDCCH monitoring. For example, in accordance with the techniques of the present disclosure, a UE 115 may be configured with a set of LP-WUS monitoring occasions associated with a DRX configuration at the UE 115, a set of LP-WUS monitoring occasions for triggering PDCCH monitoring occasions, or both. The UE 115 may then receive an LP-WUS within one of the sets of LP-WUS monitoring occasions and monitor for a corresponding downlink message.

Reference will again be made to FIG. 2.

Some wireless communications systems may implement LP-WUSs 245 as another power-saving mechanism at the UE 115-a. In particular, in accordance with aspects of the present disclosure, the wireless communications system 200 may utilize LP-WUS 245 triggered PDCCH monitoring with C-DRX configuration as a power saving procedure. For LP-WUS 245 triggered PDCCH monitoring, the UE 115-a may be equipped with a LP-WUR 240, which may exhibit lower complexity and lower power consumption as compared to the main radio 235. The main radio 235 may be able to receive and process complex waveforms, but may take longer wait times to turn on and off. Comparatively, the LP-WUR 240 may be capable of receiving and processing simple signals (e.g., limited bandwidth and simpler waveform), but may be switched on and off quickly. As such, the LP-WUR 240 may use significantly less power to operate as compared to the main radio 235.

In accordance with some aspects of the present disclosure, in order to reduce power consumption associated with the DRX configuration 210, the network entity 105-a may utilize LP-WUSs 245 during the monitoring occasions 230 in order to trigger active periods 220 (e.g., PDCCH monitoring occasions) of the DRX configuration. LP-WUSs 245 may include a simpler waveform (e.g., on-off keying (OOK) waveform) waveform as compared to PDCCH messages, thereby enabling the UE 115-a to utilize the LP-WUR 240 to receive the LP-WUSs 245 (instead of having to use the main radio 235 for receiving PDCCH messages).

For example, in the context of LP-WUS 245 triggered PDCCH monitoring, the UE 115-a may switch off the main radio 235 to save power (e.g., UE 115-a turns off the main radio 235 to go into a deep sleep mode). With the main radio 235 off, the UE 115-a may use the LP-WUR 240 to monitor for LP-WUSs 245 during the monitoring occasions 230. If the network entity 105-a transmits an LP-WUS 245 and the UE 115-a receives the LP-WUS 245 within the monitoring occasion 230-a, the UE 115-a may switch on the main radio 235 of the UE 115-a in order to monitor for (and receive) PDCCH signaling within the active period 220-a using the main radio 235. In other words, an LP-WUS 245 received via the LP-WUR 240 during the monitoring occasion 230-a may trigger the UE 115-a to monitor for PDCCH signaling using the main radio 235 during the active period 220 (e.g., LP-WUS 245 triggered PDCCH monitoring).

In accordance with some aspects of the present disclosure, the UE 115-a may be configured with multiple sets of LP-WUS monitoring occasions 230 that are usable for triggering PDCCH monitoring. For example, in some cases, the UE 115-a may be configured (by the network, such as via RRC signaling) with a first set of LP-WUS monitoring occasions 230 that are associated with the DRX configuration 210, and a second set of LP-WUS monitoring occasions 230 that are separate/independent from (e.g., not associated with) the DRX configuration 210. In this regard, the first set of LP-WUS monitoring occasions 230 associated with the DRX configuration 210 (e.g., DRX-related LP-WUS monitoring occasions) may be usable for triggering active periods 220 (e.g., PDCCH monitoring occasions) associated with the DRX configuration 210. Comparatively, the second set of LP-WUS monitoring occasions 230 that are not associated with the DRX configuration 210 (e.g., non-DRX LP-WUS monitoring occasions) may be usable for triggering active periods 220 (e.g., PDCCH monitoring occasions) that are separate/independent from (e.g., not associated with) the DRX configuration 210. In some cases, the first and second sets of LP-WUS monitoring occasions 230 may be associated with different periodicities.

In order to combine DRX configurations (e.g., C-DRX) and LP-WUS-triggered PDCCH monitoring, aspects of the present disclosure are directed to signaling and configurations for replacing DCP messages (e.g., DCP messages 310) with LP-WUS messages, and for configuring additional LP-WUS monitoring occasions that are not associated with (e.g., separate/independent from) DRX configurations 210. Additionally, aspects of the present disclosure are directed to signaling and configurations that enable UEs 115 to determine when to monitor for PDCCH triggered by LP-WUSs, as well as how the UEs 115 are to monitor for such PDCCH (e.g., which/how timers for PDCCH monitoring should be configured).

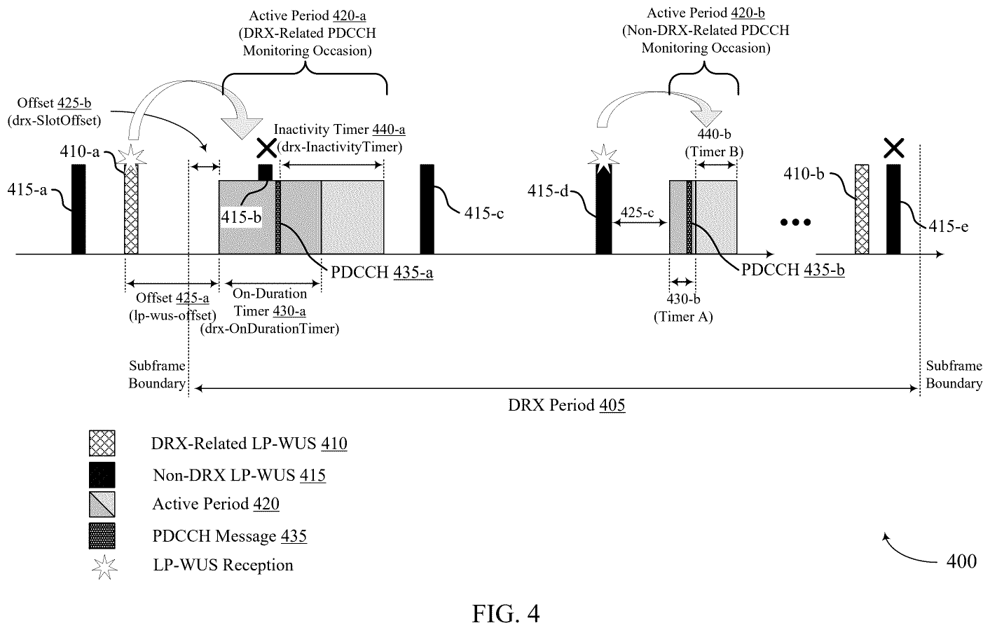

Attendant advantages of the LP-WUS-triggered PDCCH monitoring techniques described herein are further shown and described in FIG. 4.

FIG. 4 shows an example of a monitoring configuration 400 that supports techniques for DRX-augmented LP-WUS PDCCH monitoring in accordance with one or more aspects of the present disclosure. In some examples, aspects of the monitoring configuration 400 may implement, or be implemented by, aspects of the wireless communications system 100, the wireless communications system 200, the DRX configuration 300, or any combination thereof. In particular, the monitoring configuration 400 illustrates techniques for combining a C-DRX configuration with LP-WUS-triggered PDCCH monitoring, according to aspects of the present disclosure.

As described elsewhere herein, in some aspects, a UE 115 may be configured with a DRX configuration (e.g., C-DRX configuration) including multiple repeating DRX periods (e.g., DRX period 405). In accordance with some aspects of the present disclosure, a UE 115 may be configured with a first set of LP-WUS monitoring occasions 410 associated with the DRX configuration. For example, as shown in FIG. 4, the UE 115 may be configured with a first set of LP-WUS monitoring occasions 410 (e.g., a LP-WUS monitoring occasion 410-a, a LP-WUS monitoring occasion 410-b) associated with the DRX configuration, where the first set of LP-WUS monitoring occasions 410 are usable for triggering a first set of PDCCH monitoring occasions of the DRX configuration. For example, the LP-WUS monitoring occasion 410-a may be usable for triggering a first DRX-related PDCCH monitoring occasion (e.g., the active period 420-a), and the LP-WUS monitoring occasion 410-b may be usable for triggering a DRX-related PDCCH monitoring occasion in the next DRX period, immediately after DRX period 405.

Additionally, in some aspects, the UE 115 may be configured with a second set of LP-WUS monitoring occasions 415 that are not associated with the DRX configuration (e.g., second set of LP-WUS monitoring occasions 415 that are independent from the DRX configuration). For example, as shown in FIG. 4, the UE 115 may be configured with a second set of LP-WUS monitoring occasions 415 (e.g., a LP-WUS monitoring occasion 415-a, a LP-WUS monitoring occasion 415-b, a LP-WUS monitoring occasion 415-c, a LP-WUS monitoring occasion 415-d, and a LP-WUS monitoring occasion 415-e) that are unassociated associated with (e.g., separate or independent from) the DRX configuration, where the second set of LP-WUS monitoring occasions 415 are usable for triggering a second set of PDCCH monitoring occasions that are separate/independent from the DRX configuration. For example, as shown in FIG. 4, the LP-WUS monitoring occasion 415-d may be usable for triggering a non-DRX related PDCCH monitoring occasion (e.g., active period 420-b) that is separate/independent from the PDCCH monitoring occasion (e.g., active period 420-a) of the DRX configuration. The second set of LP-WUS monitoring occasions 415 (e.g., the LP-WUS monitoring occasion 415-a, the LP-WUS monitoring occasion 415-b, the LP-WUS monitoring occasion 415-c, the LP-WUS monitoring occasion 415-d, and the LP-WUS monitoring occasion 415-e), together with the first set of LP-WUS monitoring occasions 410 (e.g., the LP-WUS monitoring occasion 410-a and the LP-WUS monitoring occasion 410-b), may enable the UE 115 to have more than one active period or more than one PDCCH monitoring occasion (e.g., more than one active period 420) within a time window whose duration is equal to DRX period 405.

In some aspects, the first set of LP-WUS monitoring occasions 410 and the second set of LP-WUS monitoring occasions 415 may be configured by the network via the same or different control signaling (e.g., same RRC message, different RRC messages). As described elsewhere herein, the first set of LP-WUS monitoring occasions 410 and the second set of LP-WUS monitoring occasions 415 may be usable for communicating LP-WUSs that are associated with a relatively simplified waveform (e.g., OOK waveform) that may be received via the LP-WUR 240 of the UE 115.

The first set of LP-WUS monitoring occasions 410 associated with the DRX configuration may enable increased power saving and reduced latency when the UE 115 has occasional, periodic, and/or regular downlink traffic from the network. Comparatively, the second set of LP-WUS monitoring occasions 415 that are separate/independent from the DRX configuration may provide increased latency reduction when the UE 115 has occasional, bursty, and/or irregular downlink traffic from the network. As such, configuring the UE 115 with both sets of LP-WUS monitoring occasions (e.g., the first set of LP-WUS monitoring occasions 410 and the second set of LP-WUS monitoring occasions 415) may enable benefits of both respective designs.

Configuring the UE 115 with different sets of LP-WUS monitoring occasions may provide more opportunities for the network to inform the UE 115 of data traffic to be communicated to the UE 115, thereby reducing a latency of the data traffic. In particular, the first set of LP-WUS monitoring occasion 410 may be associated with a different periodicity as compared to the second set of LP-WUS monitoring occasions 415. For example, as shown in FIG. 4, the first set of LP-WUS monitoring occasions 410 may be associated with a first periodicity such that there is one LP-WUS monitoring occasion from the first set of LP-WUS monitoring occasions 410 within or for each DRX period 405. Comparatively, the second set of LP-WUS monitoring occasions 415 may be associated with a second periodicity such that there are multiple LP-WUS monitoring occasions 415 from the second set of LP-WUS monitoring occasions 415 within or for each DRX period 405 (or some time window with a duration that is equal to DRX period 405). In this regard, the second set of LP-WUS monitoring occasions 415 may provide additional opportunities within any time window equal in duration to the DRX period 405 for the network to inform the UE 115 of data traffic that is to be delivered to the UE 115.

The periodicity of the first set of LP-WUS monitoring occasions 410 and the second set of LP-WUS monitoring occasions 415 for triggering PDCCH monitoring occasions is non-trivial. In particular, the periodicities of the respective sets of LP-WUS monitoring occasions may determine a relative timing of the PDCCH monitoring occasion (e.g., active periods 420) triggered by LP-WUSs received in the respective LP-WUS monitoring occasion.

For example, as shown in FIG. 4, each LP-WUS monitoring occasion from the first set of LP-WUS monitoring occasions 410 may be usable for triggering an active period 420 (e.g., DRX-related PDCCH monitoring occasion) in a corresponding DRX cycle/period. For instance, reception of an LP-WUS via the LP-WUS monitoring occasion 410-a may be used to trigger a DRX-related PDCCH monitoring occasion (e.g., active period 420-b) in the DRX period 405. Similarly, reception of an LP-WUS via the LP-WUS monitoring occasion 410-b may be used to trigger a DRX-related PDCCH monitoring occasion (e.g., active period 420-b) in a corresponding DRX cycle/period that is immediately after DRX period 405.

Comparatively, at least some of the second set of LP-WUS monitoring occasions 415 may be usable for triggering non-DRX related PDCCH monitoring occasions in the DRX period 405 that is the same as the respective LP-WUS monitoring occasion. For instance, as shown in FIG. 4, reception of an LP-WUS via the LP-WUS monitoring occasion 415-d may be used to trigger the active period 420-b (e.g., non-DRX related PDCCH monitoring occasion) in the DRX period 405 as the LP-WUS monitoring occasion 415-b and the LP-WUS monitoring occasion 415-c.

In this regard, the first set of LP-WUS monitoring occasions 410 associated with the DRX configuration may enable increased power saving and reduced latency when the UE 115 has occasional, periodic, and/or regular downlink traffic from the network. Comparatively, the second set of LP-WUS monitoring occasions 415 that are independent from the DRX configuration may provide increased latency reduction when the UE 115 has occasional, bursty, and/or irregular downlink traffic from the network. As such, configuring the UE 115 with both sets of LP-WUS monitoring occasions (e.g., the first set of LP-WUS monitoring occasions 410 and the second set of LP-WUS monitoring occasions 415) may enable benefits of both respective designs.

As described elsewhere herein, the position of the second set of LP-WUS monitoring occasions 415 in the time domain may not be tied to the DRX configuration, and may therefore be more flexible as compared to the position of the first set of LP-WUS monitoring occasions 410. For example, as described previously herein, a position of the first set of LP-WUS monitoring occasions 410 in the time domain may be determined (e.g., inferred, derived) based on a position of the DRX-related PDCCH monitoring occasions (e.g., active periods 420) of the DRX configuration. That is, the DRX periods 405 and corresponding PDCCH monitoring occasions/active periods 420 of the DRX configuration may be fixed or static once configured, where the position of the first set of LP-WUS monitoring occasions 410 are based on the position of the PDCCH monitoring occasions/active periods 420 of the DRX configuration.

Comparatively, the position of the second set of LP-WUS monitoring occasions 415 may not be based on (e.g., tied to) the DRX configuration. As such, the non-DRX related PDCCH monitoring occasions (e.g., active period 420-b) may be based on a position of the second set of LP-WUS monitoring occasions 415 in the time domain. In this regard, non-DRX related PDCCH monitoring occasions (e.g., an active period 420-b that is a non-DRX related active period) may “float” or “slide” in the time domain based on the corresponding LP-WUS monitoring occasion 415 from the second set of LP-WUS monitoring occasions 415 that is used to receive an LP-WUS.

To summarize, in the context of a DRX configuration, the position of the PDCCH monitoring occasions/active periods 420 are fixed, where the position of the first set of LP-WUS monitoring occasions 410 is determined (e.g., fixed) based on the position of the PDCCH monitoring occasions/active periods 420. Comparatively, the position of the second set of LP-WUS monitoring occasions 415 may be flexible or freely configured or configured independent of DRX configuration, where the position of the non-DRX PDCCH monitoring occasions/active periods 420 may be based on the position of the second set of LP-WUS monitoring occasions 415.

The UE 115 may be configured to monitor (using the LP-WUR 240) both the first set of LP-WUS monitoring occasions 410 and the second set of LP-WUS monitoring occasions 415. In some aspects, the first set of LP-WUS monitoring occasions 410 associated with the DRX configuration and the second set of LP-WUS monitoring occasions 415 that are separate/independent from the DRX configuration may be associated with different timers for activating/implementing the respective active periods 420/PDCCH monitoring occasions.

For example, upon receiving an LP-WUS via the LP-WUS monitoring occasion 410-a from the first set of LP-WUS monitoring occasions 410, the UE 115 may be configured to start an active period 420-a (e.g., DRX-related PDCCH monitoring occasion) following an offset 425-a (e.g., lp-wus-Offset). As noted previously herein, the LP-WUS monitoring occasion 410-a may be in one slot/subframe, and the corresponding active period 420-a/PDCCH monitoring occasion may be in the subsequent slot/subframe. That is, the lp-wus-Offset (e.g., offset 425-a) may define a time where the UE 115 starts monitoring for detection of LP-WUS prior to a slot/subframe where the drx-onDurationTimer would start on the PCell or on the SpCell (e.g., lp-wus-Offset is for detecting LP-WUS associated with DRX cycle). In some aspects, the offset 425-a (e.g., lp-wus-Offset) may be greater than the wake up time for the main radio 235 (e.g., offset 425-a provides sufficient time for the UE 115 to activate/wake up the main radio 235 prior to the active period 420-a/PDCCH monitoring occasion). In some cases, the active period 420-a/DRX-related PDCCH monitoring occasion may start some offset 425-b (e.g., drx-SlotOffset) following the slot/subframe boundary separating the LP-WUS monitoring occasion 410-a and the active period 420-a.

As described previously herein, the UE 115 may activate/start an on-duration timer 430-a (e.g., drx-OnDurationTimer) for the active period 420-a. The UE 115 may be configured to monitor for PDCCH messages 435 (e.g., a PDCCH message 435-a) using the main radio 235 for a duration of the on-duration timer 430-a (e.g., while drx-OnDurationTimer is running). If the UE 115 receives a PDCCH message 435-a during the active period 420-a, the UE 115 may activate/start an inactivity timer 440-a (e.g., drx-InactivityTimer) to extend the active period 420-a (e.g., extend the DRX-related PDCCH monitoring occasion). For example, the PDCCH message 435-a may schedule another communication to be performed by the UE 115, and the UE 115 may extend the active period 420-a by activating the inactivity timer 440-a in order to perform the scheduled communication within the active period 420-a.

Referring now to the second set of LP-WUS monitoring occasions 415, the second set of LP-WUS monitoring occasions 415 may be associated with a different periodicity and different set of offsets/timers as compared to the first set of LP-monitoring occasions 410. For example, upon receiving an LP-WUS via the LP-WUS monitoring occasion 415-d, the UE 115 may be configured to start an active period 420-b some offset 425-c after receiving the LP-WUS via the LP-WUS monitoring occasion 415-d, where the offset 425-c may be the same or different as compared to the offset 425-a. As noted previously herein, the offset 425-c may be based on (e.g., greater than) the time used to wake up or activate the main radio 235 of the UE 115. Further, the UE 115 may activate/start an on-duration timer 430-b (e.g., Timer A) for the active period 420-b (e.g., non-DRX related PDCCH monitoring occasion). That is, Timer A (which may be the same or different duration as compared to drx-OnDurationTimer) may be triggered by reception of the LP-WUS via the LP-WUS monitoring occasion 415-d, and may be started some time duration (defined by offset 425-c) after LP-WUS reception.

Continuing with reference to the active period 420-b (e.g., non-DRX related PDCCH monitoring occasion), the UE 115 may be configured to monitor for PDCCH messages 435-b using the main radio 235 for a duration of the on-duration timer 430-b (e.g., while Timer A is running). If the UE 115 receives a PDCCH message 435 (e.g., a PDCCH message 435-b) during the active period 420-b, the UE 115 may activate/start an inactivity timer 440-b (e.g., Timer B) to extend the active period 420-b (e.g., extend the non-DRX-related PDCCH monitoring occasion). For example, the PDCCH message 435-b may schedule another communication to be performed by the UE 115, and the UE 115 may extend the active period 420-b by activating the inactivity timer 440-b in order to perform the scheduled communication within the active period 420-b. Timer B may be the same or different duration as the drx-InactivityTimer.

With both sets of LP-WUS monitoring occasions (e.g., the first set of LP-WUS monitoring occasions 410 and the second set of LP-WUS monitoring occasions 415) configured, there may be times where there are multiple timers running. In such cases, if Timer A (on-duration timer 430-b) or Timer B (e.g., inactivity timer 440-b) is running after a start of drx-OnDurationTimer (e.g., while the on-duration timer 430-a is running), the UE 115 may be configured to stop Timer A and/or Timer B, and operate in accordance with the drx-OnDurationTimer for a DRX-related PDCCH monitoring occasion. Similarly, if an any of the first set of LP-WUS monitoring occasions 410 associated with the DRX configuration overlap with Timer A or Timer B, the UE 115 may be expected to behave as if an LP-WUS associated with a DRX cycle is received (e.g., start the drx-OnDurationTimer associated with the next DRX cycle). In other words, Timer A and Timer B are both stopped, and control is given to the DRX process.

In some aspects, the UE 115 may be configured/allowed to transmit periodic or semi-persistent sounding reference signal (SRS) communications and/or channel state information (CSI) reports during DRX-related PDCCH monitoring occasions, but may not transmit such SRS messages and/or CSI reports during non-DRX related PDCCH monitoring occasions. For example, the UE 115 may be allowed to transmit SRS messages and/or CSI reports during the active period 420-a (e.g., PDCCH monitoring occasion) associated with the DRX configuration, but may be configured to refrain from transmitting such SRS messages and/or CSI reports during the active period 420-b (e.g., PDCCH monitoring occasion) that is triggered by LP-WUS received in the second set of LP-WUS monitoring occasions 415 that are configured separate/independent from the DRX configuration. In some aspects, the control signaling used to configure the DRX configuration and/or respective sets of LP-WUS monitoring occasions (e.g., the first set of LP-WUS monitoring occasions 410 and the second set of LP-WUS monitoring occasions 415) may indicate whether corresponding active periods 420/PDCCH monitoring occasions may be used to communicate different types of data or messages, such as SRSs, CSI reports, etc.

In some aspects, the UE 115 may not be expected to monitor any LP-WUS monitoring occasions 415 that occur between an LP-WUS monitoring occasion 410 from the first set of LP-WUS monitoring occasions 410 and a corresponding DRX-related PDCCH monitoring occasion. In other words, the UE 115 may not be expected to monitor any LP-WUS monitoring occasions 415 that occur during the offsets 425-a, the offset 425-b, or both (e.g., during lp-wus-Offset and/or drx-SlotOffset) and before the start of the on-duration timer 430-a. For example, as shown in FIG. 4, the LP-WUS monitoring occasion 415-e from the second set of LP-WUS monitoring occasions 415 may occur between the LP-WUS monitoring occasion 410-b and a corresponding active period 420/DRX-related PDCCH monitoring occasion triggered by the LP-WUS monitoring occasion 410-b. In this regard, the UE 115 may be configured to refrain from monitoring the LP-WUS monitoring occasion 415-e based on the LP-WUS monitoring occasion 415-e occurring between the LP-WUS monitoring occasion 410-b and the corresponding DRX-related PDCCH monitoring occasion in the time domain (e.g., based on the LP-WUS monitoring occasion 415-e occurring during the offset 425-a associated with the LP-WUS monitoring occasion 410-b).

Similarly, the UE 115 may not be expected to monitor for any LP-WUS monitoring occasions 415 that occur while the drx-onDurationTimer (e.g., on-duration timer 430-a) or the drx-InactivityTimer (e.g., inactivity timer 440-a) of the DRX configuration is running. For example, as shown in FIG. 4, the UE 115 may refrain from monitoring the LP-WUS monitoring occasion 415-b based on the LP-WUS monitoring occasion 415-b occurring while the on-duration timer 430-a is running.

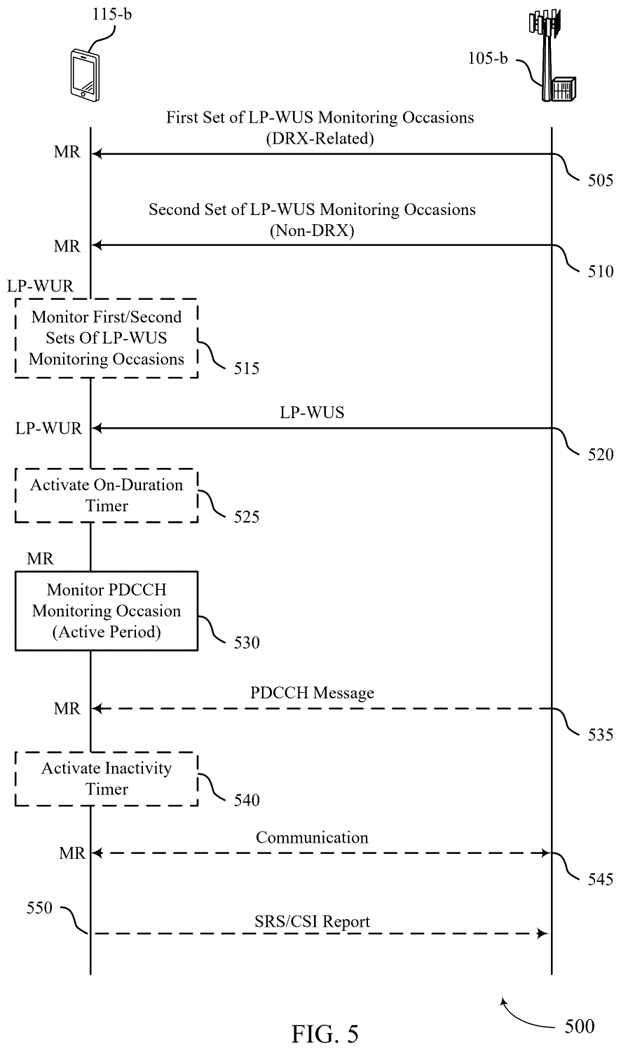

FIG. 5 shows an example of a process flow 500 that supports techniques for DRX-augmented LP-WUS PDCCH monitoring in accordance with one or more aspects of the present disclosure. In some examples, aspects of the process flow 500 may implement, or be implemented by, aspects of the wireless communications system 100, the wireless communications system 200, the DRX configuration 300, the monitoring configuration 400, or any combination thereof. In particular, the process flow 500 illustrates techniques for combining a C-DRX configuration with LP-WUS-triggered PDCCH monitoring, according to aspects of the present disclosure.

The process flow 500 includes a network entity 105-b and a UE 115-b, which may be examples of wireless devices as described herein. For example, the network entity 105-b and the UE 115-b illustrated in FIG. 5 may include examples of the network entity 105-a and the UE 115-a, respectively, as illustrated in FIG. 2.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-b may receive control signaling (e.g., RRC signaling) indicating a first set of LP-WUS monitoring occasions associated with a DRX configuration at the UE 115-a. The first set of LP-WUS monitoring occasions may be usable for triggering a first set of downlink control channel monitoring occasions (e.g., PDCCH monitoring occasions) of the DRX configuration. For example, as shown in FIG. 4, the UE 115-b may be configured with a first set of LP-WUS monitoring occasions 410 that are usable for triggering active periods 420 (e.g., PDCCH monitoring occasions) associated with the DRX configuration.

As noted previously herein, a position of the first set of LP-WUS monitoring occasions in a time domain may be determined based on a position of the first set of PDCCH monitoring occasions of the DRX configuration in the time domain. The position of the first set of PDCCH monitoring occasions of the DRX configuration in the time domain may be based on parameters drx-LongCycleStartOffset and drx-SlotOffset of the DRX configuration. In some cases, as shown in FIG. 4, each LP-WUS monitoring occasion 410 from the first set of LP-WUS monitoring occasions 410 may be positioned an offset 425-a prior to a corresponding active period 420-a/PDCCH monitoring occasion associated with the DRX configuration.

At 510, the UE 115-b may receive control signaling (e.g., RRC signaling) indicating a second set of LP-WUS monitoring occasions that are usable for triggering a second set of downlink control channel monitoring occasions (e.g., PDCCH monitoring occasions) that are separate from (e.g., not associated with, independent from) the DRX configuration. For example, as shown in FIG. 4, the UE 115-b may be configured with a second set of LP-WUS monitoring occasions 415 that are usable for triggering active periods 420 (e.g., PDCCH monitoring occasions) that are separate from (e.g., not associated with) the DRX configuration.

In some implementations, the first set of LP-WUS monitoring occasions at 505 and the second set of LP-WUS monitoring occasions at 510 may be configured via the same or different control signaling. For example, in some cases, the first and second sets of LP-WUS monitoring occasions may be configured via a single RRC message, or via separate RRC messages.

As noted previously herein, in some aspects, a position of the second set of PDCCH monitoring occasions that are separate from the DRX configuration may be based on a position of the second set of LP-WUS monitoring occasions in the time domain. That is, the second set of PDCCH monitoring occasions (e.g., active period 420-b in FIG. 4) may “float” or “slide” in the time domain based on the location of the second set of LP-WUS monitoring occasions in the time domain.

In some aspects, the periodicity of the first and second sets of LP-WUS monitoring occasions may be the same or different. For example, in some cases, as shown in FIG. 4, a periodicity of the second set of LP-WUS monitoring occasions 415 may be shorter than a periodicity of the first set of LP-WUS monitoring occasions 410 such that each DRX period 405 comprises multiple LP-WUS monitoring occasions 410 from the second set of LP-WUS monitoring occasions 415.

At 515, the UE 115-b may monitor both the first set of LP-WUS monitoring occasions and the second set of LP-WUS monitoring occasions (e.g., using a LP-WUR of the UE 115-b). The UE 115-b may monitor both sets of LP-WUS monitoring occasions at 515 based on receiving/being configured with the first set of LP-WUS monitoring occasions at 505 and the second set of LP-WUS monitoring occasions at 510.

At 520, the UE 115-b may receive a LP-WUS via an LP-WUS monitoring occasion from the first or second set of LP-WUS monitoring occasions. The UE 115-b may receive the LP-WUS at 520 using a LP-WUR of the UE 115-b, where the LP-WUS may include an OOK waveform. The UE 115-b may receive the LP-WUS at 520 based on being configured with the first and second sets of LP-WUS monitoring occasions at 505 and 510, monitoring the first/second sets of LP-WUS monitoring occasions at 515, or any combination thereof.

At 525, the UE 115-b may activate an on-duration timer for a PDCCH monitoring occasion (e.g., active period 420) based on receiving the LP-WUS at 520. The type of on-duration timer activated by the UE 115-b may be based on whether the LP-WUS was received via the first set of LP-WUS monitoring occasions or the second set of LP-WUS monitoring occasions.

For example, as shown in FIG. 4, if the LP-WUS is received within a LP-WUS monitoring occasion 410-a that is associated with the DRX configuration, the UE 115-b may activate a drx-OnDurationTimer (e.g., on-duration timer 430-a) associated with the PDCCH monitoring occasion (e.g., active period 420-a) of the DRX configuration. Comparatively, if the if the LP-WUS is received within a LP-WUS monitoring occasion 415-d that is separate from the DRX configuration, the UE 115-b may activate Timer A (e.g., on-duration timer 430-b) associated with the PDCCH monitoring occasion (e.g., active period 420-b) that is separate from (e.g., independent from) DRX configuration.

At 530, the UE 115-b may monitor for PDCCH signaling from the network entity 105-b within the activated PDCCH monitoring occasion (e.g., active period 420) while the on-duration timer is running. For example, as shown in FIG. 4, the UE 115-a may monitor for PDCCH while the drx-OnDurationTimer is running (e.g., for a DRX-related PDCCH monitoring occasion/active period 420-a), or while Timer A is running (e.g., for a non-DRX-related PDCCH monitoring occasion/active period 420-b). The UE 115-a may monitor the respective PDCCH monitoring occasions at 530 using the main radio 235 of the UE 115-b. In some aspects, the duration of Timer A may be the same or different as compared to the drx-OnDurationTimer.

At 535, the UE 115-b may receive a PDCCH message from the network entity 105-b via the PDCCH monitoring occasion (e.g., via the main radio 235). The UE 115-b may receive the PDCCH message at 535 based on activating the on-duration timer at 525, monitoring the PDCCH monitoring occasion at 530, or both. In particular, the UE 115-b may receive the PDCCH message while the on-duration timer is running. For example, as shown in FIG. 4, the UE 115-b may receive a PDCCH message 435-a during the active period 420-a (e.g., DRX-related PDCCH monitoring occasion).

In some aspects, the PDCCH message may indicate or schedule an additional communication that is to be performed by the UE 115-b, such as a downlink communication, an uplink communication, and/or a sidelink communication.

At 540, the UE 115-b may activate an inactivity timer associated with the respective PDCCH monitoring occasion. In particular, the UE 115-b may activate the inactivity timer at 540 to extend the PDCCH monitoring occasion (e.g., extend the active period 420) in order to perform the communication scheduled by the PDCCH message at 535. The type of inactivity timer activated by the UE 115-b may be based on whether the PDCCH message was received via a DRX-related PDCCH monitoring occasion or a non-DRX PDCCH monitoring occasion.

For example, as shown in FIG. 4, if the PDCCH message 435-a is received within a DRX-related PDCCH monitoring occasion (e.g., active period 420-a), the UE 115-b may activate a drx-InactivityTimer (e.g., inactivity timer 440-a). Comparatively, if the PDCCH message 435-b is received within a non-DRX-related PDCCH monitoring occasion (e.g., active period 420-b), the UE 115-b may activate Timer B (e.g., inactivity timer 440-b). In some aspects, the duration of Timer B may be the same or different as compared to the drx-InactivityTimer.

At 545, the UE 115-b may perform the communication scheduled by the PDCCH message at 535. In particular, the UE 115-b may perform the communication during the PDCCH monitoring occasion (e.g., during the active period 420), and based on activating the inactivity timer to extend the PDCCH monitoring occasion/active period 420.

At 550, the UE 115-b may transmit an SRS, a CSI report, or both, during the PDCCH monitoring occasion/active period 420. Whether or not the UE 115-b is allowed/expected to transmit the SRS/CSI report during the PDCCH monitoring occasion may be dependent on the type of PDCCH monitoring occasion (e.g., whether or not the PDCCH monitoring occasion is DRX-related or non-DRX-related). For example, as shown in FIG. 4, the UE 115-b may be allowed/expected to transmit SRS/CSI reports via the active period 420-a associated with the DRX configuration (e.g., DRX-related PDCCH monitoring occasion), but may not be allowed/expected to transmit SRS/CSI reports via the active period 420-b that is separate from the DRX configuration (e.g., non-RX-related PDCCH monitoring occasion).

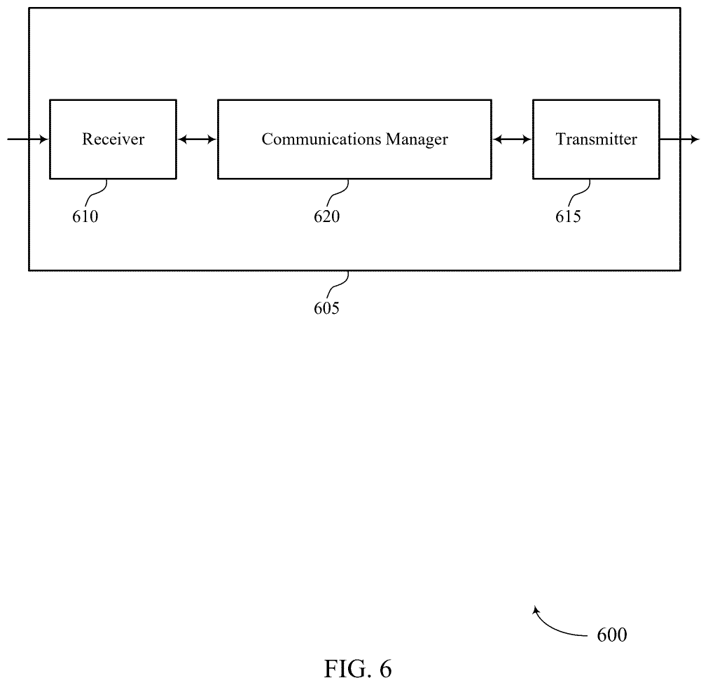

FIG. 6 shows a block diagram 600 of a device 605 that supports techniques for DRX-augmented LP-WUS PDCCH monitoring in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for DRX-augmented LP-WUS PDCCH monitoring). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for DRX-augmented LP-WUS PDCCH monitoring). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for DRX-augmented LP-WUS PDCCH monitoring as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving, from a network entity, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. The communications manager 620 is capable of, configured to, or operable to support a means for receiving, from the network entity, an indication of a second set of LP-WUS monitoring occasions, where the second set of LP-WUS monitoring occasions is usable for triggering a second set of downlink control channel monitoring occasions that are separate from the DRX configuration. The communications manager 620 is capable of, configured to, or operable to support a means for receiving a LP-WUS within one of the first set of LP-WUS monitoring occasions or the second set of LP-WUS monitoring occasions. The communications manager 620 is capable of, configured to, or operable to support a means for monitoring for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques that enable the UEs 115 of the wireless communications system 100 to be configured with multiple different sets of LP-WUS monitoring occasions, thereby providing more opportunities for the network to alert the UEs 115 of data traffic, and enabling the UEs 115 to trigger active periods more frequently. As such, techniques described herein may reduce a latency of downlink traffic from the network to the UEs 115. Furthermore, by utilizing LP-WUSs to trigger PDCCH monitoring in the context of a DRX configuration, aspects of the present disclosure may enable UEs 115 to perform LP-WUS monitoring using an LP-WUR that exhibits lower power consumption as compared to the main radio. Therefore, techniques described herein may further lower a power consumption at the UEs 115 associated with performing LP-WUS monitoring during inactive periods of a DRX cycle.

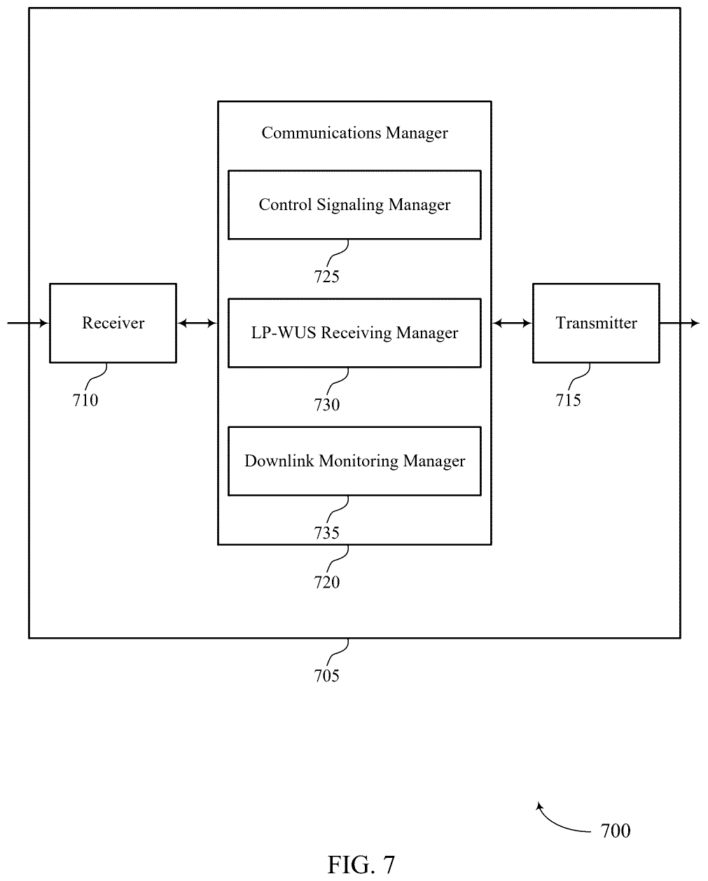

FIG. 7 shows a block diagram 700 of a device 705 that supports techniques for DRX-augmented LP-WUS PDCCH monitoring in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for DRX-augmented LP-WUS PDCCH monitoring). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for DRX-augmented LP-WUS PDCCH monitoring). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for DRX-augmented LP-WUS PDCCH monitoring as described herein. For example, the communications manager 720 may include a control signaling manager 725, an LP-WUS receiving manager 730, a downlink monitoring manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The control signaling manager 725 is capable of, configured to, or operable to support a means for receiving, from a network entity, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. The control signaling manager 725 is capable of, configured to, or operable to support a means for receiving, from the network entity, an indication of a second set of LP-WUS monitoring occasions, where the second set of LP-WUS monitoring occasions is usable for triggering a second set of downlink control channel monitoring occasions that are separate from the DRX configuration. The LP-WUS receiving manager 730 is capable of, configured to, or operable to support a means for receiving a LP-WUS within one of the first set of LP-WUS monitoring occasions or the second set of LP-WUS monitoring occasions. The downlink monitoring manager 735 is capable of, configured to, or operable to support a means for monitoring for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

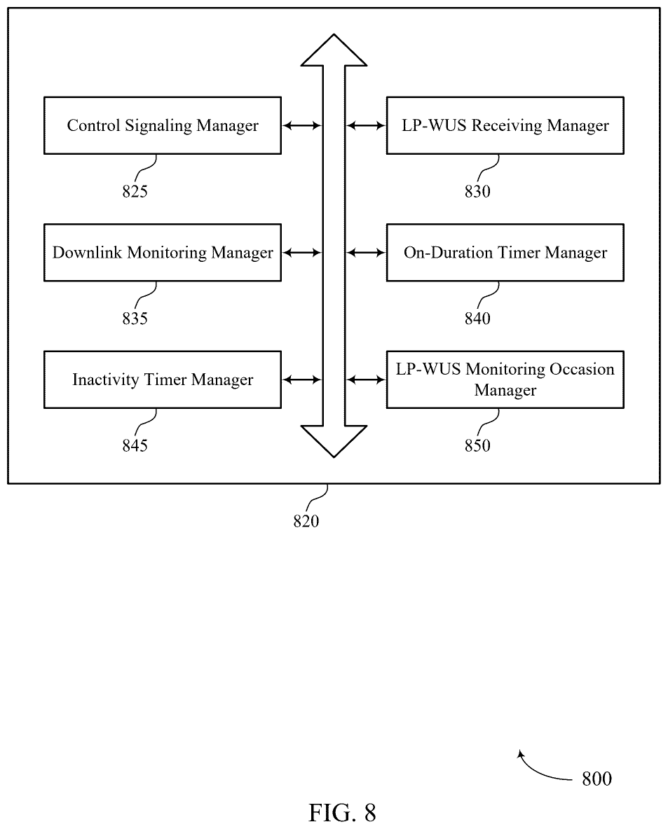

FIG. 8 shows a block diagram 800 of a communications manager 820 that supports techniques for DRX-augmented LP-WUS PDCCH monitoring in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for DRX-augmented LP-WUS PDCCH monitoring as described herein. For example, the communications manager 820 may include a control signaling manager 825, an LP-WUS receiving manager 830, a downlink monitoring manager 835, an on-duration timer manager 840, an inactivity timer manager 845, an LP-WUS monitoring occasion manager 850, or any combination thereof. Each of these components, or components or subcomponents thereof (e.g., one or more processors, one or more memories), may communicate, directly or indirectly, with one another (e.g., via one or more buses).

The control signaling manager 825 is capable of, configured to, or operable to support a means for receiving, from a network entity, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. In some examples, the control signaling manager 825 is capable of, configured to, or operable to support a means for receiving, from the network entity, an indication of a second set of LP-WUS monitoring occasions, where the second set of LP-WUS monitoring occasions is usable for triggering a second set of downlink control channel monitoring occasions that are separate from the DRX configuration. The LP-WUS receiving manager 830 is capable of, configured to, or operable to support a means for receiving a LP-WUS within one of the first set of LP-WUS monitoring occasions or the second set of LP-WUS monitoring occasions. The downlink monitoring manager 835 is capable of, configured to, or operable to support a means for monitoring for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

In some examples, a position of the first set of LP-WUS monitoring occasions in a time domain is determined based on a position of the first set of downlink control channel monitoring occasions of the DRX configuration in the time domain.

In some examples, a position of the second set of downlink control channel monitoring occasions in a time domain is based on a position of the second set of LP-WUS monitoring occasions in the time domain.

In some examples, a second periodicity of the second set of LP-WUS monitoring occasions is shorter than a first periodicity of the first set of LP-WUS monitoring occasions such that each DRX period includes multiple LP-WUS monitoring occasions from the second set of LP-WUS monitoring occasions.

In some examples, the LP-WUS monitoring occasion manager 850 is capable of, configured to, or operable to support a means for receiving an indication to change the second periodicity of the second set of LP-WUS monitoring occasions, where reception of the LP-WUS, the downlink control channel message being monitored for, or both, is based on reception of the indication to change the second periodicity.

In some examples, each LP-WUS monitoring occasion from the first set of LP-WUS monitoring occasions is positioned a first offset prior to a corresponding downlink control channel monitoring occasion from the first set of downlink control channel monitoring occasions in a time domain. In some examples, each downlink control channel monitoring occasion from the second set of downlink control channel monitoring occasions is positioned a second offset subsequent to a corresponding LP-WUS monitoring occasion from the second set of LP-WUS monitoring occasions.

In some examples, the on-duration timer manager 840 is capable of, configured to, or operable to support a means for activating a first on-duration timer associated with the DRX configuration if the LP-WUS is received within one of the first set of LP-WUS monitoring occasions, where the downlink control channel message is monitored for within a downlink control channel monitoring occasion from the first set of downlink control channel monitoring occasions while the first on-duration timer is running. In some examples, the on-duration timer manager 840 is capable of, configured to, or operable to support a means for activating a second on-duration timer that is different from the first on-duration timer and separate from the DRX configuration if the LP-WUS is received within one of the second set of LP-WUS monitoring occasions, where the downlink control channel message is monitored for within a downlink control channel monitoring occasion from the second set of downlink control channel monitoring occasions while the second on-duration timer is running.

In some examples, the inactivity timer manager 845 is capable of, configured to, or operable to support a means for activating a first inactivity timer associated with the DRX configuration if the LP-WUS is received within one of the first set of LP-WUS monitoring occasions and a downlink control channel message is received within one of the first set of downlink control channel monitoring occasions, and. In some examples, the inactivity timer manager 845 is capable of, configured to, or operable to support a means for activating a second inactivity timer that is different from the first inactivity timer and independent from the DRX configuration if the LP-WUS is received within one of the second set of LP-WUS monitoring occasions and the downlink control channel message is received within one of the second set of downlink control channel monitoring occasions.

In some examples, the first set of downlink control channel monitoring occasions of the DRX configuration is usable for transmission of a SRS, a CSI report, or both. In some examples, the second set of downlink control channel monitoring occasions is not usable for transmission of a SRS, a CSI report, or both.

In some examples, the LP-WUS receiving manager 830 is capable of, configured to, or operable to support a means for refraining from monitoring a second LP-WUS monitoring occasion from the second set of LP-WUS monitoring occasions based on the second LP-WUS monitoring occasion occurring between a first LP-WUS monitoring occasion from the first set of LP-WUS monitoring occasions and a corresponding downlink control channel monitoring occasion from the first set of downlink control channel monitoring occasions in a time domain.

In some examples, the on-duration timer manager 840 is capable of, configured to, or operable to support a means for activating a first on-duration timer associated with the DRX configuration, a first inactivity timer associated with the DRX configuration, or both, based on reception of the LP-WUS within one of the first set of LP-WUS monitoring occasions. In some examples, the LP-WUS receiving manager 830 is capable of, configured to, or operable to support a means for refraining from monitoring an LP-WUS monitoring occasion from the second set of LP-WUS monitoring occasions based on the LP-WUS monitoring occasion occurring while the first on-duration timer or the first inactivity timer is running.

In some examples, the LP-WUS received within one of the first set of LP-WUS monitoring occasions or the second set of LP-WUS monitoring occasions includes an on-off keying waveform.

In some examples, the control signaling is received via a main radio of the UE. In some examples, the LP-WUS is received via a LP-WUR of the UE. In some examples, monitoring for the downlink control channel message is performed using the main radio.

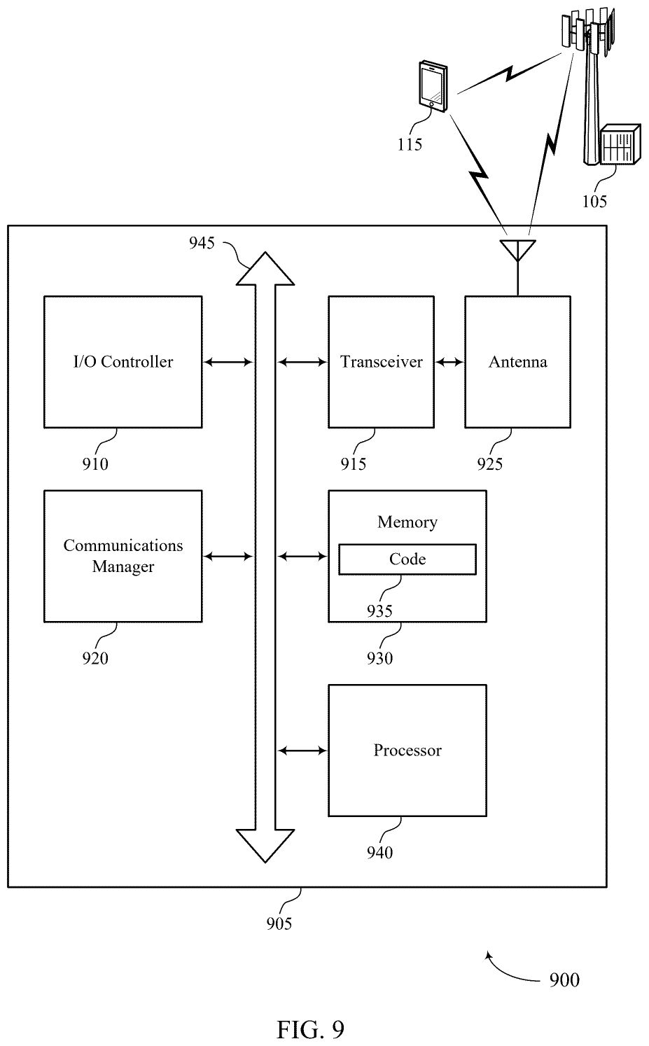

FIG. 9 shows a diagram of a system 900 including a device 905 that supports techniques for DRX-augmented LP-WUS PDCCH monitoring in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for DRX-augmented LP-WUS PDCCH monitoring). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

For example, the communications manager 920 is capable of, configured to, or operable to support a means for receiving, from a network entity, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. The communications manager 920 is capable of, configured to, or operable to support a means for receiving, from the network entity, an indication of a second set of LP-WUS monitoring occasions, where the second set of LP-WUS monitoring occasions is usable for triggering a second set of downlink control channel monitoring occasions that are separate from the DRX configuration. The communications manager 920 is capable of, configured to, or operable to support a means for receiving a LP-WUS within one of the first set of LP-WUS monitoring occasions or the second set of LP-WUS monitoring occasions. The communications manager 920 is capable of, configured to, or operable to support a means for monitoring for a downlink control channel message within a downlink control channel monitoring occasion from the first set of downlink control channel monitoring occasions or the second set of downlink control channel monitoring occasions based on reception of the LP-WUS within the first set of LP-WUS monitoring occasions or the second set of LP-WUS monitoring occasions.

By including or configuring the communications manager 920 in accordance with examples as described herein, the device 905 may support techniques that enable the UEs 115 of the wireless communications system 100 to be configured with multiple different sets of LP-WUS monitoring occasions, thereby providing more opportunities for the network to alert the UEs 115 of data traffic, and enabling the UEs 115 to trigger active periods more frequently. As such, techniques described herein may reduce a latency of downlink traffic from the network to the UEs 115. Furthermore, by utilizing LP-WUSs to trigger PDCCH monitoring in the context of a DRX configuration, aspects of the present disclosure may enable UEs 115 to perform LP-WUS monitoring using an LP-WUR that exhibits lower power consumption as compared to the main radio. Therefore, techniques described herein may further lower a power consumption at the UEs 115 associated with performing LP-WUS monitoring during inactive periods of a DRX cycle.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for DRX-augmented LP-WUS PDCCH monitoring as described herein, or the at least one processor 940 and the at least one memory 930 may be otherwise configured to, individually or collectively, perform or support such operations.

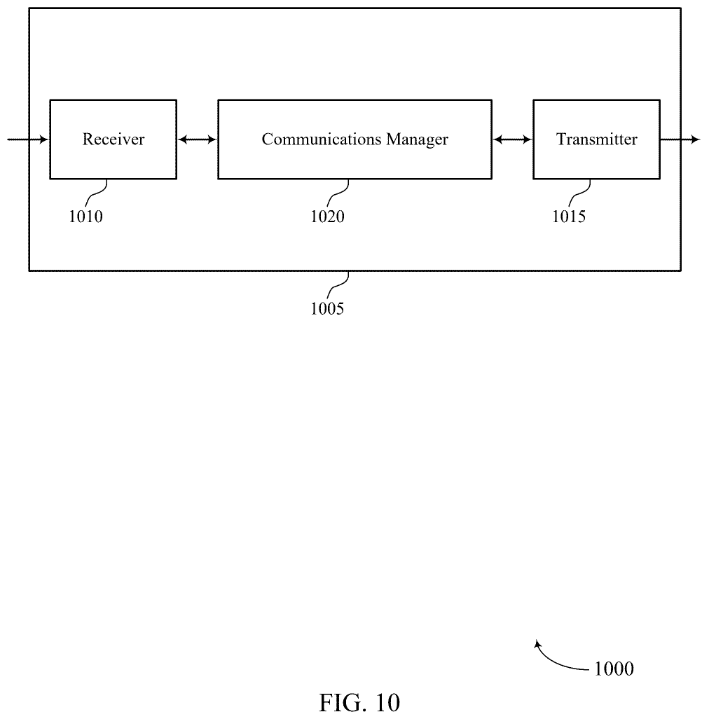

FIG. 10 shows a block diagram 1000 of a device 1005 that supports techniques for DRX-augmented LP-WUS PDCCH monitoring in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for DRX-augmented LP-WUS PDCCH monitoring as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for outputting, to a UE, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. The communications manager 1020 is capable of, configured to, or operable to support a means for outputting, to the UE, an indication of a second set of LP-WUS monitoring occasions, where the second set of LP-WUS monitoring occasions is usable for triggering a second set of downlink control channel monitoring occasions that are separate from the DRX configuration. The communications manager 1020 is capable of, configured to, or operable to support a means for outputting a LP-WUS within one of the first set of LP-WUS monitoring occasions or the second set of LP-WUS monitoring occasions. The communications manager 1020 is capable of, configured to, or operable to support a means for outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques that enable the UEs 115 of the wireless communications system 100 to be configured with multiple different sets of LP-WUS monitoring occasions, thereby providing more opportunities for the network to alert the UEs 115 of data traffic, and enabling the UEs 115 to trigger active periods more frequently. As such, techniques described herein may reduce a latency of downlink traffic from the network to the UEs 115. Furthermore, by utilizing LP-WUSs to trigger PDCCH monitoring in the context of a DRX configuration, aspects of the present disclosure may enable UEs 115 to perform LP-WUS monitoring using an LP-WUR that exhibits lower power consumption as compared to the main radio. Therefore, techniques described herein may further lower a power consumption at the UEs 115 associated with performing LP-WUS monitoring during inactive periods of a DRX cycle.

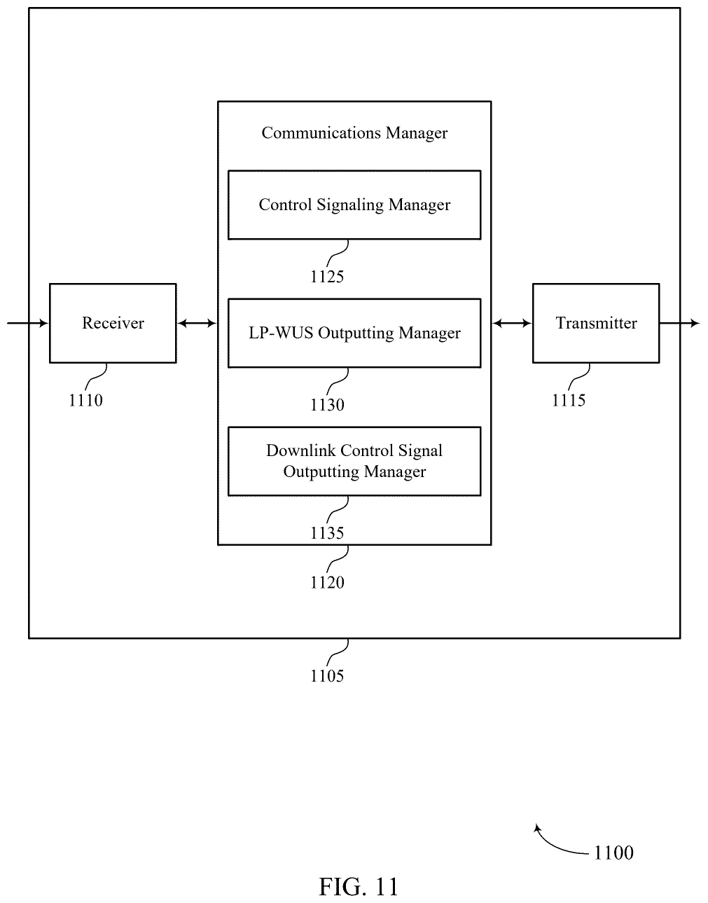

FIG. 11 shows a block diagram 1100 of a device 1105 that supports techniques for DRX-augmented LP-WUS PDCCH monitoring in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for DRX-augmented LP-WUS PDCCH monitoring as described herein. For example, the communications manager 1120 may include a control signaling manager 1125, an LP-WUS outputting manager 1130, a downlink control signal outputting manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The control signaling manager 1125 is capable of, configured to, or operable to support a means for outputting, to a UE, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. The control signaling manager 1125 is capable of, configured to, or operable to support a means for outputting, to the UE, an indication of a second set of LP-WUS monitoring occasions, where the second set of LP-WUS monitoring occasions is usable for triggering a second set of downlink control channel monitoring occasions that are separate from the DRX configuration. The LP-WUS outputting manager 1130 is capable of, configured to, or operable to support a means for outputting a LP-WUS within one of the first set of LP-WUS monitoring occasions or the second set of LP-WUS monitoring occasions. The downlink control signal outputting manager 1135 is capable of, configured to, or operable to support a means for outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

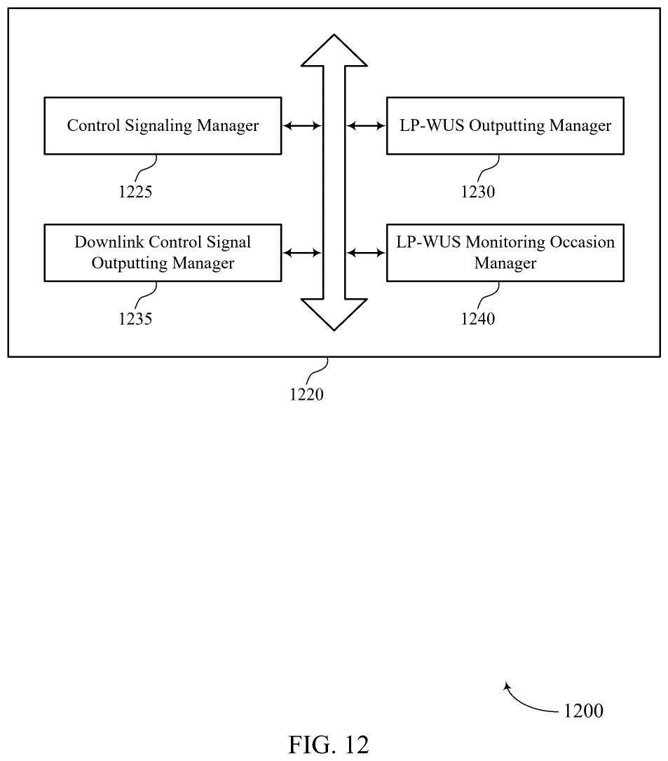

FIG. 12 shows a block diagram 1200 of a communications manager 1220 that supports techniques for DRX-augmented LP-WUS PDCCH monitoring in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for DRX-augmented LP-WUS PDCCH monitoring as described herein. For example, the communications manager 1220 may include a control signaling manager 1225, an LP-WUS outputting manager 1230, a downlink control signal outputting manager 1235, an LP-WUS monitoring occasion manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control signaling manager 1225 is capable of, configured to, or operable to support a means for outputting, to a UE, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. In some examples, the control signaling manager 1225 is capable of, configured to, or operable to support a means for outputting, to the UE, an indication of a second set of LP-WUS monitoring occasions, where the second set of LP-WUS monitoring occasions is usable for triggering a second set of downlink control channel monitoring occasions that are separate from the DRX configuration. The LP-WUS outputting manager 1230 is capable of, configured to, or operable to support a means for outputting a LP-WUS within one of the first set of LP-WUS monitoring occasions or the second set of LP-WUS monitoring occasions. The downlink control signal outputting manager 1235 is capable of, configured to, or operable to support a means for outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

In some examples, a position of the first set of LP-WUS monitoring occasions in a time domain is determined based on a position of the first set of downlink control channel monitoring occasions of the DRX configuration in the time domain.

In some examples, a position of the second set of downlink control channel monitoring occasions in a time domain is based on a position of the second set of LP-WUS monitoring occasions in the time domain.

In some examples, a second periodicity of the second set of LP-WUS monitoring occasions is shorter than a first periodicity of the first set of LP-WUS monitoring occasions such that each DRX period includes multiple LP-WUS monitoring occasions from the second set of LP-WUS monitoring occasions.

In some examples, the LP-WUS monitoring occasion manager 1240 is capable of, configured to, or operable to support a means for outputting an indication to change the second periodicity of the second set of LP-WUS monitoring occasions, where output of the LP-WUS, output of the downlink control channel message, or both, is based on output of the indication to change the second periodicity.

In some examples, each LP-WUS monitoring occasion from the first set of LP-WUS monitoring occasions is positioned a first offset prior to a corresponding downlink control channel monitoring occasion from the first set of downlink control channel monitoring occasions in a time domain. In some examples, each downlink control channel monitoring occasion from the second set of downlink control channel monitoring occasions is positioned a second offset subsequent to a corresponding LP-WUS monitoring occasion from the second set of LP-WUS monitoring occasions.

In some examples, if the LP-WUS is output within one of the first set of LP-WUS monitoring occasions, the LP-WUS indicates to activate a first on-duration timer associated with the DRX configuration. In some examples, the downlink control channel message is output within a downlink control channel monitoring occasion from the first set of downlink control channel monitoring occasions while the first on-duration timer is running. In some examples, if the LP-WUS is output within one of the second set of LP-WUS monitoring occasions, the LP-WUS indicates to activate a second on-duration timer that is different from the first on-duration timer and independent from the DRX configuration. In some examples, the downlink control channel message is output within a downlink control channel monitoring occasion from the second set of downlink control channel monitoring occasions while the second on-duration timer is running.

In some examples, if the LP-WUS is output within one of the first set of LP-WUS monitoring occasions and the downlink control channel message is output within one of the first set of downlink control channel monitoring occasions, the downlink control channel message indicates to activate a first inactivity timer associated with the DRX configuration. In some examples, if the LP-WUS is output within one of the second set of LP-WUS monitoring occasions and the downlink control channel message is output within one of the second set of downlink control channel monitoring occasions, the downlink control channel message indicates to activate a second inactivity timer that is different from the first inactivity timer and independent from the DRX configuration.

In some examples, the first set of downlink control channel monitoring occasions of the DRX configuration is usable for output of a SRS, a CSI report, or both. In some examples, the second set of downlink control channel monitoring occasions is not usable for output of a SRS, a CSI report, or both.

In some examples, the LP-WUS output within one of the first set of LP-WUS monitoring occasions or the second set of LP-WUS monitoring occasions includes an on-off keying waveform.

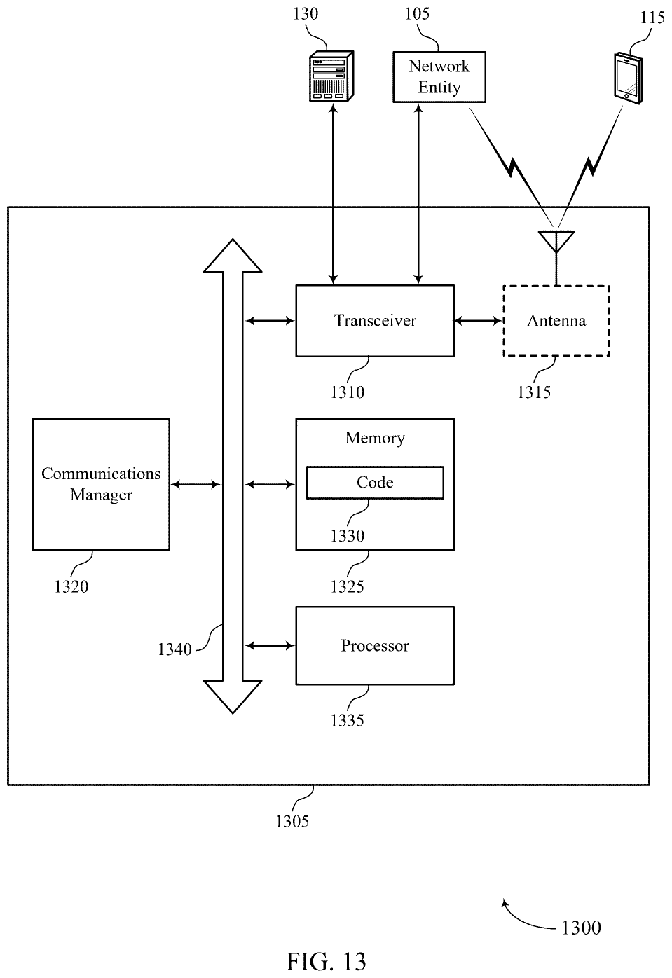

FIG. 13 shows a diagram of a system 1300 including a device 1305 that supports techniques for DRX-augmented LP-WUS PDCCH monitoring in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for DRX-augmented LP-WUS PDCCH monitoring). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

For example, the communications manager 1320 is capable of, configured to, or operable to support a means for outputting, to a UE, control signaling indicating a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration. The communications manager 1320 is capable of, configured to, or operable to support a means for outputting, to the UE, an indication of a second set of LP-WUS monitoring occasions, where the second set of LP-WUS monitoring occasions is usable for triggering a second set of downlink control channel monitoring occasions that are separate from the DRX configuration. The communications manager 1320 is capable of, configured to, or operable to support a means for outputting a LP-WUS within one of the first set of LP-WUS monitoring occasions or the second set of LP-WUS monitoring occasions. The communications manager 1320 is capable of, configured to, or operable to support a means for outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions.

By including or configuring the communications manager 1320 in accordance with examples as described herein, the device 1305 may support techniques that enable the UEs 115 of the wireless communications system 100 to be configured with multiple different sets of LP-WUS monitoring occasions, thereby providing more opportunities for the network to alert the UEs 115 of data traffic, and enabling the UEs 115 to trigger active periods more frequently. As such, techniques described herein may reduce a latency of downlink traffic from the network to the UEs 115. Furthermore, by utilizing LP-WUSs to trigger PDCCH monitoring in the context of a DRX configuration, aspects of the present disclosure may enable UEs 115 to perform LP-WUS monitoring using an LP-WUR that exhibits lower power consumption as compared to the main radio. Therefore, techniques described herein may further lower a power consumption at the UEs 115 associated with performing LP-WUS monitoring during inactive periods of a DRX cycle.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for DRX-augmented LP-WUS PDCCH monitoring as described herein, or the at least one processor 1335 and the at least one memory 1325 may be otherwise configured to, individually or collectively, perform or support such operations.

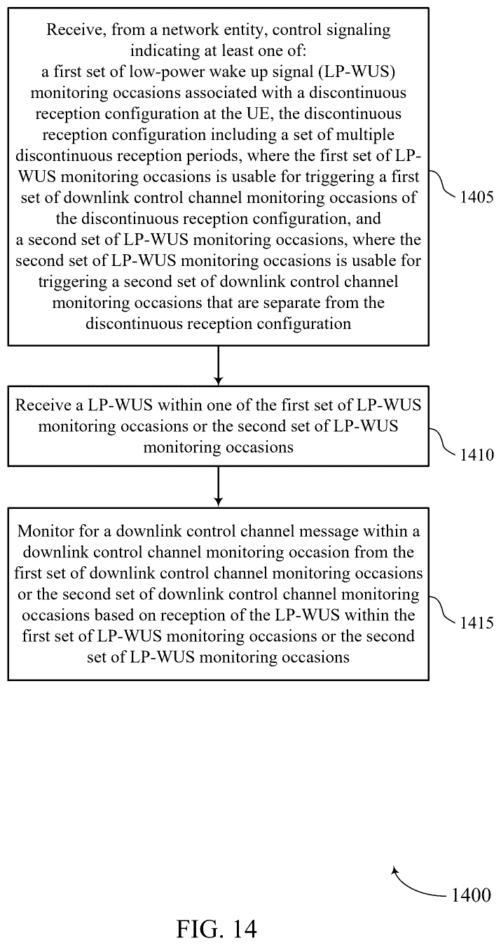

FIG. 14 shows a flowchart illustrating a method 1400 that supports techniques for DRX-augmented LP-WUS PDCCH monitoring in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, control signaling indicating at least one of a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration. The operations of 1405 may be performed in accordance with examples as disclosed herein. In some examples, aspects of the operations of 1405 may be performed by a control signaling manager 825 as described with reference to FIG. 8.

At 1410, the method may include receiving a LP-WUS within one of the first set of LP-WUS monitoring occasions or the second set of LP-WUS monitoring occasions. The operations of 1410 may be performed in accordance with examples as disclosed herein. In some examples, aspects of the operations of 1410 may be performed by an LP-WUS receiving manager 830 as described with reference to FIG. 8.

At 1415, the method may include monitoring for a downlink control channel message within a downlink control channel monitoring occasion from or associated with the first set of downlink control channel monitoring occasions or the second set of downlink control channel monitoring occasions based on reception of the LP-WUS within the first set of LP-WUS monitoring occasions or the second set of LP-WUS monitoring occasions. The operations of 1415 may be performed in accordance with examples as disclosed herein. In some examples, aspects of the operations of 1415 may be performed by a downlink monitoring manager 835 as described with reference to FIG. 8.

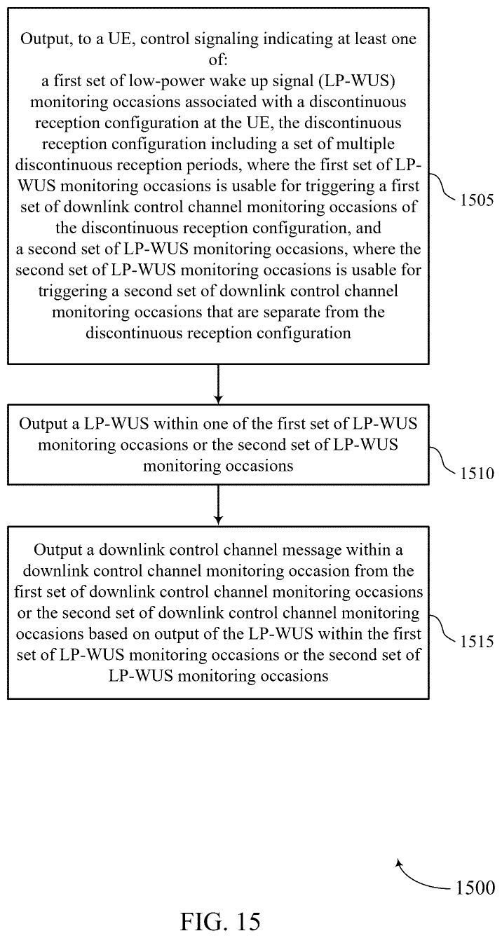

FIG. 15 shows a flowchart illustrating a method 1500 that supports techniques for DRX-augmented LP-WUS PDCCH monitoring in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, control signaling indicating at least one of a first set of low-power wake up signal (LP-WUS) monitoring occasions associated with a DRX configuration at the UE, the DRX configuration including a set of multiple DRX periods, where the first set of LP-WUS monitoring occasions is usable for triggering a first set of downlink control channel monitoring occasions of the DRX configuration, and a second set of LP-WUS monitoring occasions, where the second set of LP-WUS monitoring occasions is usable for triggering a second set of downlink control channel monitoring occasions that are separate from the DRX configuration. The operations of 1505 may be performed in accordance with examples as disclosed herein. In some examples, aspects of the operations of 1505 may be performed by a control signaling manager 1225 as described with reference to FIG. 12.

At 1510, the method may include outputting a LP-WUS within one of the first set of LP-WUS monitoring occasions or the second set of LP-WUS monitoring occasions. The operations of 1510 may be performed in accordance with examples as disclosed herein. In some examples, aspects of the operations of 1510 may be performed by an LP-WUS outputting manager 1230 as described with reference to FIG. 12.

At 1515, the method may include outputting a downlink control channel message within a downlink control channel monitoring occasion from the first set of downlink control channel monitoring occasions or the second set of downlink control channel monitoring occasions based on output of the LP-WUS within the first set of LP-WUS monitoring occasions or the second set of LP-WUS monitoring occasions. The operations of 1515 may be performed in accordance with examples as disclosed herein. In some examples, aspects of the operations of 1515 may be performed by a downlink control signal outputting manager 1235 as described with reference to FIG. 12.

The following provides an overview of aspects of the present disclosure:

Aspect 1: A method for wireless communications at a UE, comprising: receiving, from a network entity, control signaling indicating at least one of: a first set of LP-WUS monitoring occasions associated with a DRX configuration at the UE, the DRX configuration comprising a plurality of DRX periods, wherein the first set of LP-WUS monitoring occasions is usable for triggering a first set of downlink control channel monitoring occasions of the DRX configuration, and a second set of LP-WUS monitoring occasions, wherein the second set of LP-WUS monitoring occasions is usable for triggering a second set of downlink control channel monitoring occasions that are separate from the DRX configuration; receiving a LP-WUS within one of the first set of LP-WUS monitoring occasions or the second set of LP-WUS monitoring occasions; and monitoring for a downlink control channel message within a downlink control channel monitoring occasion from the first set of downlink control channel monitoring occasions or the second set of downlink control channel monitoring occasions based at least in part on reception of the LP-WUS within the first set of LP-WUS monitoring occasions or the second set of LP-WUS monitoring occasions.

Aspect 2: The method of aspect 1, wherein a position of the first set of LP-WUS monitoring occasions in a time domain is determined based at least in part on a position of the first set of downlink control channel monitoring occasions of the DRX configuration in the time domain.

Aspect 3: The method of any of aspects 1 through 2, wherein a position of the second set of downlink control channel monitoring occasions in a time domain is based at least in part on a position of the second set of LP-WUS monitoring occasions in the time domain.

Aspect 4: The method of any of aspects 1 through 3, wherein a second periodicity of the second set of LP-WUS monitoring occasions is shorter than a first periodicity of the first set of LP-WUS monitoring occasions such that each DRX period comprises multiple LP-WUS monitoring occasions from the second set of LP-WUS monitoring occasions.

Aspect 5: The method of aspect 4, further comprising: receiving an indication to change the second periodicity of the second set of LP-WUS monitoring occasions, wherein reception of the LP-WUS, the downlink control channel message being monitored for, or both, is based at least in part on reception of the indication to change the second periodicity.

Aspect 6: The method of any of aspects 1 through 5, wherein each LP-WUS monitoring occasion from the first set of LP-WUS monitoring occasions is positioned a first offset prior to a corresponding downlink control channel monitoring occasion from the first set of downlink control channel monitoring occasions in a time domain, and each downlink control channel monitoring occasion from the second set of downlink control channel monitoring occasions is positioned a second offset subsequent to a LP-WUS monitoring occasion from the second set of LP-WUS monitoring occasions used to receive a respective LP-WUS.

Aspect 7: The method of any of aspects 1 through 6, further comprising: activating a first on-duration timer associated with the DRX configuration if the LP-WUS is received within one of the first set of LP-WUS monitoring occasions, wherein the downlink control channel message is monitored for within a downlink control channel monitoring occasion from the first set of downlink control channel monitoring occasions while the first on-duration timer is running, and activating a second on-duration timer that is different from the first on-duration timer and separate from the DRX configuration if the LP-WUS is received within one of the second set of LP-WUS monitoring occasions, wherein the downlink control channel message is monitored for within a downlink control channel monitoring occasion from the second set of downlink control channel monitoring occasions while the second on-duration timer is running.

Aspect 8: The method of any of aspects 1 through 7, further comprising: activating a first inactivity timer associated with the DRX configuration if the LP-WUS is received within one of the first set of LP-WUS monitoring occasions and a downlink control channel message is received within one of the first set of downlink control channel monitoring occasions, and activating a second inactivity timer that is different from the first inactivity timer and independent from the DRX configuration if the LP-WUS is received within one of the second set of LP-WUS monitoring occasions and the downlink control channel message is received within one of the second set of downlink control channel monitoring occasions.

Aspect 9: The method of any of aspects 1 through 8, wherein the first set of downlink control channel monitoring occasions of the DRX configuration is usable for transmission of an SRS, a CSI report, or both, and the second set of downlink control channel monitoring occasions is not usable for transmission of an SRS, a CSI report, or both.

Aspect 10: The method of any of aspects 1 through 9, further comprising: refraining from monitoring a second LP-WUS monitoring occasion from the second set of LP-WUS monitoring occasions based at least in part on the second LP-WUS monitoring occasion occurring between a first LP-WUS monitoring occasion from the first set of LP-WUS monitoring occasions and a corresponding downlink control channel monitoring occasion from the first set of downlink control channel monitoring occasions in a time domain.

Aspect 11: The method of any of aspects 1 through 10, further comprising: activating a first on-duration timer associated with the DRX configuration, a first inactivity timer associated with the DRX configuration, or both, based at least in part on reception of the LP-WUS within one of the first set of LP-WUS monitoring occasions; and refraining from monitoring an LP-WUS monitoring occasion from the second set of LP-WUS monitoring occasions based at least in part on the LP-WUS monitoring occasion occurring while the first on-duration timer or the first inactivity timer is running.

Aspect 12: The method of any of aspects 1 through 11, wherein the LP-WUS received within one of the first set of LP-WUS monitoring occasions or the second set of LP-WUS monitoring occasions comprises an OOK waveform.

Aspect 13: The method of any of aspects 1 through 12, wherein the control signaling is received via a main radio of the UE, the LP-WUS is received via a LP-WUR of the UE, and monitoring for the downlink control channel message is performed using the main radio.

Aspect 14: A method for wireless communications at a network entity, comprising: outputting, to a UE, control signaling indicating at least one of: a first set of LP-WUS monitoring occasions associated with a DRX configuration at the UE, the DRX configuration comprising a plurality of DRX periods, wherein the first set of LP-WUS monitoring occasions is usable for triggering a first set of downlink control channel monitoring occasions of the DRX configuration, and a second set of LP-WUS monitoring occasions, wherein the second set of LP-WUS monitoring occasions is usable for triggering a second set of downlink control channel monitoring occasions that are separate from the DRX configuration; outputting a LP-WUS within one of the first set of LP-WUS monitoring occasions or the second set of LP-WUS monitoring occasions; and outputting a downlink control channel message within a downlink control channel monitoring occasion from the first set of downlink control channel monitoring occasions or the second set of downlink control channel monitoring occasions based at least in part on output of the LP-WUS within the first set of LP-WUS monitoring occasions or the second set of LP-WUS monitoring occasions.

Aspect 15: The method of aspect 14, wherein a position of the first set of LP-WUS monitoring occasions in a time domain is determined based at least in part on a position of the first set of downlink control channel monitoring occasions of the DRX configuration in the time domain.

Aspect 16: The method of any of aspects 14 through 15, wherein a position of the second set of downlink control channel monitoring occasions in a time domain is based at least in part on a position of the second set of LP-WUS monitoring occasions in the time domain.

Aspect 17: The method of any of aspects 14 through 16, wherein a second periodicity of the second set of LP-WUS monitoring occasions is shorter than a first periodicity of the first set of LP-WUS monitoring occasions such that each DRX period comprises multiple LP-WUS monitoring occasions from the second set of LP-WUS monitoring occasions.

Aspect 18: The method of aspect 17, further comprising: outputting an indication to change the second periodicity of the second set of LP-WUS monitoring occasions, wherein output of the LP-WUS, output of the downlink control channel message, or both, is based at least in part on output of the indication to change the second periodicity.

Aspect 19: The method of any of aspects 14 through 18, wherein each LP-WUS monitoring occasion from the first set of LP-WUS monitoring occasions is positioned a first offset prior to a corresponding downlink control channel monitoring occasion from the first set of downlink control channel monitoring occasions in a time domain, and each downlink control channel monitoring occasion from the second set of downlink control channel monitoring occasions is positioned a second offset subsequent to a LP-WUS monitoring occasion from the second set of LP-WUS monitoring occasions used to receive a respective LP-WUS.

Aspect 20: The method of any of aspects 14 through 19, wherein if the LP-WUS is output within one of the first set of LP-WUS monitoring occasions, the LP-WUS indicates to activate a first on-duration timer associated with the DRX configuration, the downlink control channel message is output within a downlink control channel monitoring occasion from the first set of downlink control channel monitoring occasions while the first on-duration timer is running, and if the LP-WUS is output within one of the second set of LP-WUS monitoring occasions, the LP-WUS indicates to activate a second on-duration timer that is different from the first on-duration timer and independent from the DRX configuration, the downlink control channel message is output within a downlink control channel monitoring occasion from the second set of downlink control channel monitoring occasions while the second on-duration timer is running.

Aspect 21: The method of any of aspects 14 through 20, wherein if the LP-WUS is output within one of the first set of LP-WUS monitoring occasions and the downlink control channel message is output within one of the first set of downlink control channel monitoring occasions, the downlink control channel message indicates to activate a first inactivity timer associated with the DRX configuration, and if the LP-WUS is output within one of the second set of LP-WUS monitoring occasions and the downlink control channel message is output within one of the second set of downlink control channel monitoring occasions, the downlink control channel message indicates to activate a second inactivity timer that is different from the first inactivity timer and independent from the DRX configuration.

Aspect 22: The method of any of aspects 14 through 21, wherein the first set of downlink control channel monitoring occasions of the DRX configuration is usable for output of an SRS, a CSI report, or both, and the second set of downlink control channel monitoring occasions is not usable for output of an SRS, a CSI report, or both.

Aspect 23: The method of any of aspects 14 through 22, wherein the LP-WUS output within one of the first set of LP-WUS monitoring occasions or the second set of LP-WUS monitoring occasions comprises an OOK waveform.

Aspect 24: A UE comprising one or more memories storing processor-executable code, and one or more processors coupled with the one or more memories and individually or collectively operable to execute the code to cause the UE to perform a method of any of aspects 1 through 13.

Aspect 25: A UE comprising at least one means for performing a method of any of aspects 1 through 13.

Aspect 26: A non-transitory computer-readable medium storing code the code comprising instructions executable by one or more processors to perform a method of any of aspects 1 through 13.

Aspect 27: A network entity comprising one or more memories storing processor-executable code, and one or more processors coupled with the one or more memories and individually or collectively operable to execute the code to cause the network entity to perform a method of any of aspects 14 through 23.

Aspect 28: A network entity comprising at least one means for performing a method of any of aspects 14 through 23.

Aspect 29: A non-transitory computer-readable medium storing code the code comprising instructions executable by one or more processors to perform a method of any of aspects 14 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, control signaling indicating at least one of:
a first set of low-power wake up signal (LP-WUS) monitoring occasions associated with a discontinuous reception configuration at the UE, the discontinuous reception configuration comprising a plurality of discontinuous reception periods, wherein the first set of LP-WUS monitoring occasions is usable for triggering a first set of downlink control channel monitoring occasions of the discontinuous reception configuration, and
a second set of LP-WUS monitoring occasions, wherein the second set of LP-WUS monitoring occasions is usable for triggering a second set of downlink control channel monitoring occasions that are separate from the discontinuous reception configuration;
receive an LP-WUS within one of the first set of LP-WUS monitoring occasions or the second set of LP-WUS monitoring occasions; and
monitor for a downlink control channel message within a downlink control channel monitoring occasion from the first set of downlink control channel monitoring occasions or the second set of downlink control channel monitoring occasions based at least in part on reception of the LP-WUS within the first set of LP-WUS monitoring occasions or the second set of LP-WUS monitoring occasions.

2. The UE of claim 1, wherein each LP-WUS monitoring occasion from the first set of LP-WUS monitoring occasions is positioned an offset prior to a corresponding downlink control channel monitoring occasion from the first set of downlink control channel monitoring occasions in a time domain.

3. The UE of claim 1, wherein each downlink control channel monitoring occasion from the second set of downlink control channel monitoring occasions is positioned an offset subsequent to a LP-WUS monitoring occasion from the second set of LP-WUS monitoring occasions used to receive a respective LP-WUS.

4. The UE of claim 1, wherein the one or more processors are individually or collectively further operable to execute the code to cause the UE to:
activate a first on-duration timer associated with the discontinuous reception configuration if the LP-WUS is received within one of the first set of LP-WUS monitoring occasions, wherein the downlink control channel message is monitored for within a downlink control channel monitoring occasion from the first set of downlink control channel monitoring occasions while the first on-duration timer is running, and
activate a second on-duration timer that is different from the first on-duration timer and separate from the discontinuous reception configuration if the LP-WUS is received within one of the second set of LP-WUS monitoring occasions, wherein the downlink control channel message is monitored for within a downlink control channel monitoring occasion from the second set of downlink control channel monitoring occasions while the second on-duration timer is running.

5. The UE of claim 1, wherein a position of the first set of LP-WUS monitoring occasions in a time domain is determined based at least in part on a position of the first set of downlink control channel monitoring occasions of the discontinuous reception configuration in the time domain.

6. The UE of claim 1, wherein a position of the second set of downlink control channel monitoring occasions in a time domain is based at least in part on a position of the second set of LP-WUS monitoring occasions in the time domain.

7. The UE of claim 1, wherein a second periodicity of the second set of LP-WUS monitoring occasions is shorter than a first periodicity of the first set of LP-WUS monitoring occasions such that each discontinuous reception period comprises multiple LP-WUS monitoring occasions from the second set of LP-WUS monitoring occasions.

8. The UE of claim 7, wherein the one or more processors are individually or collectively further operable to execute the code to cause the UE to:
receive an indication to change the second periodicity of the second set of LP-WUS monitoring occasions, wherein reception of the LP-WUS, the downlink control channel message being monitored for, or both, is based at least in part on reception of the indication to change the second periodicity.

9. The UE of claim 1, wherein the one or more processors are individually or collectively further operable to execute the code to cause the UE to:
activate a first inactivity timer associated with the discontinuous reception configuration if the LP-WUS is received within one of the first set of LP-WUS monitoring occasions and a downlink control channel message is received within one of the first set of downlink control channel monitoring occasions, and
activate a second inactivity timer that is different from the first inactivity timer and independent from the discontinuous reception configuration if the LP-WUS is received within one of the second set of LP-WUS monitoring occasions and the downlink control channel message is received within one of the second set of downlink control channel monitoring occasions.

10. The UE of claim 1,
wherein the first set of downlink control channel monitoring occasions of the discontinuous reception configuration is usable for transmission of a sounding reference signal, a channel state information report, or both, and
wherein the second set of downlink control channel monitoring occasions is not usable for transmission of a sounding reference signal, a channel state information report, or both.

11. The UE of claim 1, wherein the one or more processors are individually or collectively further operable to execute the code to cause the UE to:
refrain from monitoring a second LP-WUS monitoring occasion from the second set of LP-WUS monitoring occasions based at least in part on the second LP-WUS monitoring occasion occurring between a first LP-WUS monitoring occasion from the first set of LP-WUS monitoring occasions and a corresponding downlink control channel monitoring occasion from the first set of downlink control channel monitoring occasions in a time domain.

12. The UE of claim 1, wherein the one or more processors are individually or collectively further operable to execute the code to cause the UE to:
activate a first on-duration timer associated with the discontinuous reception configuration, a first inactivity timer associated with the discontinuous reception configuration, or both, based at least in part on reception of the LP-WUS within one of the first set of LP-WUS monitoring occasions; and
refrain from monitoring an LP-WUS monitoring occasion from the second set of LP-WUS monitoring occasions based at least in part on the LP-WUS monitoring occasion occurring while the first on-duration timer or the first inactivity timer is running.

13. The UE of claim 1, wherein the LP-WUS received within one of the first set of LP-WUS monitoring occasions or the second set of LP-WUS monitoring occasions comprises an on-off keying waveform.

14. The UE of claim 1, wherein the control signaling is received via a main radio of the UE, wherein the LP-WUS is received via a low-power wake-up receiver (LP-WUR) of the UE, and wherein monitoring for the downlink control channel message is performed using the main radio.

15. A method for wireless communications at a user equipment (UE), comprising:
receiving, from a network entity, control signaling indicating at least one of:
a first set of low-power wake up signal (LP-WUS) monitoring occasions associated with a discontinuous reception configuration at the UE, the discontinuous reception configuration comprising a plurality of discontinuous reception periods, wherein the first set of LP-WUS monitoring occasions is usable for triggering a first set of downlink control channel monitoring occasions of the discontinuous reception configuration, and
a second set of LP-WUS monitoring occasions, wherein the second set of LP-WUS monitoring occasions is usable for triggering a second set of downlink control channel monitoring occasions that are separate from the discontinuous reception configuration;
receiving an LP-WUS within one of the first set of LP-WUS monitoring occasions or the second set of LP-WUS monitoring occasions; and
monitoring for a downlink control channel message within a downlink control channel monitoring occasion from the first set of downlink control channel monitoring occasions or the second set of downlink control channel monitoring occasions based at least in part on reception of the LP-WUS within the first set of LP-WUS monitoring occasions or the second set of LP-WUS monitoring occasions.

16. The method of claim 15, wherein each LP-WUS monitoring occasion from the first set of LP-WUS monitoring occasions is positioned an offset prior to a corresponding downlink control channel monitoring occasion from the first set of downlink control channel monitoring occasions in a time domain.

17. The method of claim 15, wherein each downlink control channel monitoring occasion from the second set of downlink control channel monitoring occasions is positioned an offset subsequent to a LP-WUS monitoring occasion from the second set of LP-WUS monitoring occasions used to receive a respective LP-WUS.

18. A non-transitory computer-readable medium storing code at a user equipment (UE), the code comprising instructions executable by one or more processors to:
receive, from a network entity, control signaling indicating at least one of:
a first set of low-power wake up signal (LP-WUS) monitoring occasions associated with a discontinuous reception configuration at the UE, the discontinuous reception configuration comprising a plurality of discontinuous reception periods, wherein the first set of LP-WUS monitoring occasions is usable for triggering a first set of downlink control channel monitoring occasions of the discontinuous reception configuration, and
a second set of LP-WUS monitoring occasions, wherein the second set of LP-WUS monitoring occasions is usable for triggering a second set of downlink control channel monitoring occasions that are separate from the discontinuous reception configuration;
receive an LP-WUS within one of the first set of LP-WUS monitoring occasions or the second set of LP-WUS monitoring occasions; and
monitor for a downlink control channel message within a downlink control channel monitoring occasion from the first set of downlink control channel monitoring occasions or the second set of downlink control channel monitoring occasions based at least in part on reception of the LP-WUS within the first set of LP-WUS monitoring occasions or the second set of LP-WUS monitoring occasions.

19. The non-transitory computer-readable medium of claim 18, wherein each LP-WUS monitoring occasion from the first set of LP-WUS monitoring occasions is positioned an offset prior to a corresponding downlink control channel monitoring occasion from the first set of downlink control channel monitoring occasions in a time domain.

20. The non-transitory computer-readable medium of claim 18, wherein each downlink control channel monitoring occasion from the second set of downlink control channel monitoring occasions is positioned an offset subsequent to a LP-WUS monitoring occasion from the second set of LP-WUS monitoring occasions used to receive a respective LP-WUS.
